(19) United States
(12) Patent Application Publication
(10) Pub. No.: US 2026/0370435 A1
(43) Pub. Date: Nov. 19, 2026

(54) SCHEDULING FOR FREQUENCY BANDS ASSOCIATED WITH A FIRST BAND CHANGING CAPABILITY AFTER A TRANSMIT CHAIN SWITCH

(71) Applicant: QUALCOMM Incorporated, San Diego, CA (US)

(72) Inventors: Yiqing CAO, Beijing (CN); Timo Ville VINTOLA, San Diego, CA (US); Peter GAAL, San Diego, CA (US)

(21) Appl. No.: 19/138,569

(22) PCT Filed: Feb. 6, 2023
(86) PCT No.: PCT/CN2023/074521

§ 371 Date: Jun. 12, 2025

(51) Int. Cl. H04L 5/00; H04W 72/1263

(52) U.S. Cl. CPC H04L 5/0098; H04W 72/1263

(57) ABSTRACT

Methods, systems, and devices for wireless communication are described. A user equipment (UE) may transmit first capability information that indicates that a first frequency band is associated with a first band changing capability. The UE may transmit second capability information that indicates first and second switching time periods that pertain to first and second switches, by the UE, between frequency bands. The second switching time period may be longer than the first switching time period. The UE may perform the first and second switches in accordance with a scheduled frequency band change. The UE may transmit a message after at least a portion of the switching in accordance with a scheduling rule that defines whether transmission is allowed during a conditional transmission time that is after completion of the first switching time period and before completion of the second switching time period.

### CROSS REFERENCE

This application is a 371 National Stage of PCT Application No. PCT/CN 2023/074521, filed on Feb. 6, 2023, entitled “SCHEDULING FOR FREQUENCY BANDS ASSOCIATED WITH A FIRST BAND CHANGING CAPABILITY AFTER A TRANSMIT CHAIN SWITCH”, and assigned to the assignee hereof. The disclosure of the prior Application is considered part of and is incorporated by reference into this Patent Application.

### FIELD OF TECHNOLOGY

The following relates to wireless communication, including scheduling for frequency bands associated with a first band changing capability after a transmit chain switch.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a UE may be configured to support communications over two or more frequency bands. For example, the UE may be configured with one or more transmit chains that may be configured to transmit on different frequency bands. In some cases, the UE may receive signaling that schedules uplink transmissions by the UE on one or more frequency bands, and the UE may perform uplink switching to switch the transmit chains between frequency bands to perform each of the scheduled uplink transmissions.

### SUMMARY

The described techniques relate to improved methods, systems, devices, and apparatuses that support scheduling for frequency bands associated with a first band changing capability after a transmit chain switch. For example, the described techniques provide a scheduling rule for scheduling uplink transmissions by a user equipment (UE) after the UE switches from one or two source frequency bands to one or two target frequency bands, where the scheduling rule may be based on whether the source and target frequency bands support a first band changing capability. The UE may transmit first capability information to indicate at least a first frequency band that is associated with the first band changing capability. The first band changing capability may indicate that the UE will maintain a mapping between a first transmit chain of the UE and the first frequency band while performing other scheduled frequency band switches using a second transmit chain of the UE. The UE may transmit second capability information (e.g., together with or separate from the first capability information) that indicates a first switching time period and a second switching time period supported by the UE. The first switching time period may pertain to a first switch, by the UE, between the first frequency band and a second frequency band, and the second switching time period may pertain to a second switch, by the UE, between a third frequency band and the second frequency band. In some examples, the second switching time period may be longer than the first switching time period.

The UE may receive, from a network entity, scheduling information that schedules a change between communications by the UE on a band pair, that includes the first and third frequency bands, and communications by the UE on the second frequency band. The UE may switch between the band pair and the second frequency band based on the scheduling information. The switching may include performing the first switch during the first switching time period and the second switch during the second switching time period, where the first and second switching time periods overlap in time. The network entity may schedule a transmission by the UE based on the reported capability information and the scheduling rule. For example, the network entity may schedule the UE to transmit an uplink message after at least a portion of the switching. The scheduling rule may define whether the transmission is permitted during a conditional transmission time that is after the first switching time period is complete and before the second switching time period is complete. The UE may transmit the message accordingly. The described scheduling rule may thereby define protocols for scheduling uplink transmissions after a UE performs two transmit chain switches, which may improve throughput, improve coordination between devices, and reduce latency.

A method for wireless communication at a UE is described. The method may include transmitting first capability information that indicates a first frequency band is associated with a first band changing capability, where the first band changing capability indicates the UE will maintain a mapping between a first transmit chain of the UE and the first frequency band while performing other scheduled frequency band switches using a second transmit chain of the UE, transmitting second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period, receiving scheduling information that schedules a change between communications by the UE on a band pair, that includes the first frequency band and the third frequency band, and communications by the UE on the second frequency band, switching between the band pair and the second frequency band based on the scheduling information, where the switching includes the first switch and the second switch, the first switching time period of the first switch overlapping in time with the second switching time period of the second switch, and transmitting a message after at least a portion of the switching, where transmission of the message is in accordance with a scheduling rule that defines whether transmission is allowed during a conditional transmission time that is after completion of the first switching time period and before completion of the second switching time period.

A UE for wireless communication is described. The UE may include a processor, memory coupled with the processor, and instructions stored in the memory. The instructions may be executable by the processor to cause the UE to transmit first capability information that indicates a first frequency band is associated with a first band changing capability, where the first band changing capability indicates the UE will maintain a mapping between a first transmit chain of the UE and the first frequency band while performing other scheduled frequency band switches using a second transmit chain of the UE, transmit second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period, receive scheduling information that schedules a change between communications by the UE on a band pair, that includes the first frequency band and the third frequency band, and communications by the UE on the second frequency band, switch between the band pair and the second frequency band based on the scheduling information, where the switching includes the first switch and the second switch, the first switching time period of the first switch overlapping in time with the second switching time period of the second switch, and transmit a message after at least a portion of the switching, where transmission of the message is in accordance with a scheduling rule that defines whether transmission is allowed during a conditional transmission time that is after completion of the first switching time period and before completion of the second switching time period.

An apparatus for wireless communication at a UE is described. The apparatus may include means for transmitting first capability information that indicates a first frequency band is associated with a first band changing capability, where the first band changing capability indicates the UE will maintain a mapping between a first transmit chain of the UE and the first frequency band while performing other scheduled frequency band switches using a second transmit chain of the UE, means for transmitting second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period, means for receiving scheduling information that schedules a change between communications by the UE on a band pair, that includes the first frequency band and the third frequency band, and communications by the UE on the second frequency band, means for switching between the band pair and the second frequency band based on the scheduling information, where the switching includes the first switch and the second switch, the first switching time period of the first switch overlapping in time with the second switching time period of the second switch, and means for transmitting a message after at least a portion of the switching, where transmission of the message is in accordance with a scheduling rule that defines whether transmission is allowed during a conditional transmission time that is after completion of the first switching time period and before completion of the second switching time period.

A non-transitory computer-readable medium storing code for wireless communication at a UE is described. The code may include instructions executable by a processor to transmit first capability information that indicates a first frequency band is associated with a first band changing capability, where the first band changing capability indicates the UE will maintain a mapping between a first transmit chain of the UE and the first frequency band while performing other scheduled frequency band switches using a second transmit chain of the UE, transmit second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period, receive scheduling information that schedules a change between communications by the UE on a band pair, that includes the first frequency band and the third frequency band, and communications by the UE on the second frequency band, switch between the band pair and the second frequency band based on the scheduling information, where the switching includes the first switch and the second switch, the first switching time period of the first switch overlapping in time with the second switching time period of the second switch, and transmit a message after at least a portion of the switching, where transmission of the message is in accordance with a scheduling rule that defines whether transmission is allowed during a conditional transmission time that is after completion of the first switching time period and before completion of the second switching time period.

In some examples of the method, apparatuses, and non-transitory computer-readable medium described herein, the second frequency band may be associated with the first band changing capability, and transmitting the message may include operations, features, means, or instructions for transmitting the message during the conditional transmission time that may be after the completion of the first switching time period and before the completion of the second switching time period based on the scheduling rule, where the scheduling rule defines that transmission may be allowed during the conditional transmission time when the first switch may be between two frequency bands associated with the first band changing capability.

In some examples of the method, apparatuses, and non-transitory computer-readable medium described herein, transmitting the first capability information may include operations, features, means, or instructions for transmitting, via the first capability information, an indication that the second frequency band may be associated with the first band changing capability.

In some examples of the method, apparatuses, and non-transitory computer-readable medium described herein, switching between the band pair and the second frequency band may include operations, features, means, or instructions for switching from the band pair to the second frequency band, where the message may be transmitted on the second frequency band using the first transmit chain of the UE during the conditional transmission time.

In some examples of the method, apparatuses, and non-transitory computer-readable medium described herein, switching between the band pair and the second frequency band may include operations, features, means, or instructions for switching from the second frequency band to the band pair, where the message may be transmitted on the first frequency band of the band pair using the first transmit chain of the UE during the conditional transmission time.

In some examples of the method, apparatuses, and non-transitory computer-readable medium described herein, receiving the scheduling information may include operations, features, means, or instructions for receiving, via the scheduling information, an indication of resources allocated for the transmission of the message during the conditional transmission time based on the scheduling rule.

Some examples of the method, apparatuses, and non-transitory computer-readable medium described herein may further include operations, features, means, or instructions for transmitting a second message after the completion of the second switching time period, where the second message may be transmitted using the first transmit chain of the UE, the second transmit chain of the UE, or both.

In some examples of the method, apparatuses, and non-transitory computer-readable medium described herein, transmitting the message may include operations, features, means, or instructions for transmitting the message after the completion of the second switching time period based on the scheduling rule, where the scheduling rule defines that transmission may be not allowed during the conditional transmission time when a single frequency band of a set of frequency bands may be associated with the first band changing capability, the set of frequency bands including the first frequency band, the second frequency band, and the third frequency band.

In some examples of the method, apparatuses, and non-transitory computer-readable medium described herein, receiving the scheduling information may include operations, features, means, or instructions for receiving, via the scheduling information, an indication of resources allocated for the transmission of the message after the completion of the second switching time period based on the scheduling rule.

In some examples of the method, apparatuses, and non-transitory computer-readable medium described herein, switching between the band pair and the second frequency band may include operations, features, means, or instructions for switching the first transmit chain of the UE between the first frequency band and the second frequency band during the first switching time period and switching the second transmit chain of the UE between the third frequency band and the second frequency band during the second switching time period.

In some examples of the method, apparatuses, and non-transitory computer-readable medium described herein, switching between the band pair and the second frequency band may include operations, features, means, or instructions for switching from the band pair to the second frequency band in accordance with the scheduling information, where the scheduling information schedules the transmission of the message on the second frequency band.

In some examples of the method, apparatuses, and non-transitory computer-readable medium described herein, switching between the band pair and the second frequency band may include operations, features, means, or instructions for switching from the second frequency band to the band pair in accordance with the scheduling information, where the scheduling information schedules the transmission of the message on the first frequency band of the band pair, the third frequency band of the band pair, or both.

A method for wireless communication at a network entity is described. The method may include receiving first capability information that indicates a first frequency band is associated with a first band changing capability, where the first band changing capability indicates a UE will maintain a mapping between a first transmit chain of the UE and the first frequency band while performing other scheduled frequency band switches using a second transmit chain of the UE, receiving second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period, transmitting scheduling information that schedules a change between communications by the UE on a band pair, that includes the first frequency band and the third frequency band, and communications by the UE on the second frequency band, where a switch between the band pair and the second frequency band includes the first switch and the second switch, the first switching time period of the first switch overlapping in time with the second switching time period of the second switch, and receiving a message after at least a portion of the switching, where reception of the message is in accordance with a scheduling rule that defines whether transmission by the UE is allowed during a conditional transmission time that is after completion of the first switching time period and before completion of the second switching time period.

A network entity for wireless communication is described. The network entity may include a processor, memory coupled with the processor, and instructions stored in the memory. The instructions may be executable by the processor to cause the network entity to receive first capability information that indicates a first frequency band is associated with a first band changing capability, where the first band changing capability indicates a UE will maintain a mapping between a first transmit chain of the UE and the first frequency band while performing other scheduled frequency band switches using a second transmit chain of the UE, receive second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period, transmit scheduling information that schedules a change between communications by the UE on a band pair, that includes the first frequency band and the third frequency band, and communications by the UE on the second frequency band, where a switch between the band pair and the second frequency band includes the first switch and the second switch, the first switching time period of the first switch overlapping in time with the second switching time period of the second switch, and receive a message after at least a portion of the switching, where reception of the message is in accordance with a scheduling rule that defines whether transmission by the UE is allowed during a conditional transmission time that is after completion of the first switching time period and before completion of the second switching time period.

Another apparatus for wireless communication at a network entity is described. The apparatus may include means for receiving first capability information that indicates a first frequency band is associated with a first band changing capability, where the first band changing capability indicates a UE will maintain a mapping between a first transmit chain of the UE and the first frequency band while performing other scheduled frequency band switches using a second transmit chain of the UE, means for receiving second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period, means for transmitting scheduling information that schedules a change between communications by the UE on a band pair, that includes the first frequency band and the third frequency band, and communications by the UE on the second frequency band, where a switch between the band pair and the second frequency band includes the first switch and the second switch, the first switching time period of the first switch overlapping in time with the second switching time period of the second switch, and means for receiving a message after at least a portion of the switching, where reception of the message is in accordance with a scheduling rule that defines whether transmission by the UE is allowed during a conditional transmission time that is after completion of the first switching time period and before completion of the second switching time period.

A non-transitory computer-readable medium storing code for wireless communication at a network entity is described. The code may include instructions executable by a processor to receive first capability information that indicates a first frequency band is associated with a first band changing capability, where the first band changing capability indicates a UE will maintain a mapping between a first transmit chain of the UE and the first frequency band while performing other scheduled frequency band switches using a second transmit chain of the UE, receive second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period, transmit scheduling information that schedules a change between communications by the UE on a band pair, that includes the first frequency band and the third frequency band, and communications by the UE on the second frequency band, where a switch between the band pair and the second frequency band includes the first switch and the second switch, the first switching time period of the first switch overlapping in time with the second switching time period of the second switch, and receive a message after at least a portion of the switching, where reception of the message is in accordance with a scheduling rule that defines whether transmission by the UE is allowed during a conditional transmission time that is after completion of the first switching time period and before completion of the second switching time period.

In some examples of the method, apparatuses, and non-transitory computer-readable medium described herein, the second frequency band may be associated with the first band changing capability and receiving the message may include operations, features, means, or instructions for receiving the message during the conditional transmission time that may be after the completion of the first switching time period and before the completion of the second switching time period based on the scheduling rule, where the scheduling rule defines that transmission by the UE may be allowed during the conditional transmission time when the first switch may be between two frequency bands associated with the first band changing capability.

In some examples of the method, apparatuses, and non-transitory computer-readable medium described herein, receiving the first capability information may include operations, features, means, or instructions for receiving, via the first capability information, an indication that the second frequency band may be associated with the first band changing capability.

In some examples of the method, apparatuses, and non-transitory computer-readable medium described herein, the switch may be from the band pair to the second frequency band and the message may be received on the second frequency band during the conditional transmission time.

In some examples of the method, apparatuses, and non-transitory computer-readable medium described herein, the switch may be from the second frequency band to the band pair and the message may be received on the first frequency band of the band pair during the conditional transmission time.

In some examples of the method, apparatuses, and non-transitory computer-readable medium described herein, transmitting the scheduling information may include operations, features, means, or instructions for transmitting, via the scheduling information, an indication of resources allocated for the message during the conditional transmission time based on the scheduling rule.

In some examples of the method, apparatuses, and non-transitory computer-readable medium described herein, receiving the message may include operations, features, means, or instructions for receiving the message after the completion of the second switching time period based on the scheduling rule, where the scheduling rule defines that transmission by the UE may be not allowed during the conditional transmission time when a single frequency band of a set of frequency bands may be associated with the first band changing capability, the set of frequency bands including the first frequency band, the second frequency band, and the third frequency band.

In some examples of the method, apparatuses, and non-transitory computer-readable medium described herein, transmitting the scheduling information may include operations, features, means, or instructions for transmitting, via the scheduling information, an indication of resources allocated for the message after the completion of the second switching time period based on the scheduling rule.

In some examples of the method, apparatuses, and non-transitory computer-readable medium described herein, transmitting the scheduling information may include operations, features, means, or instructions for transmitting, via the scheduling information, information that schedules a change from the band pair to the second frequency band, where the scheduling information schedules the message on the second frequency band.

In some examples of the method, apparatuses, and non-transitory computer-readable medium described herein, transmitting the scheduling information may include operations, features, means, or instructions for transmitting, via the scheduling information, information that schedules a change from the second frequency band to the band pair, where the scheduling information schedules the message on the first frequency band of the band pair, the third frequency band of the band pair, or both.

### BRIEF DESCRIPTION OF THE DRAWINGS

FIG. 1 illustrates an example of a wireless communications system that supports scheduling for frequency bands associated with a first band changing capability after a transmit chain switch in accordance with one or more aspects of the present disclosure.

FIG. 2 illustrates an example of a wireless communications system that supports scheduling for frequency bands associated with a first band changing capability after a transmit chain switch in accordance with one or more aspects of the present disclosure.

FIG. 3 illustrates an example of a band switching timeline that supports scheduling for frequency bands associated with a first band changing capability after a transmit chain switch in accordance with one or more aspects of the present disclosure.

FIG. 4 illustrates an example of a band switching timeline that supports scheduling for frequency bands associated with a first band changing capability after a transmit chain switch in accordance with one or more aspects of the present disclosure.

FIG. 5 illustrates an example of a process flow that supports scheduling for frequency bands associated with a first band changing capability after a transmit chain switch in accordance with one or more aspects of the present disclosure.

FIGS. 6 and 7 illustrate block diagrams of devices that support scheduling for frequency bands associated with a first band changing capability after a transmit chain switch in accordance with one or more aspects of the present disclosure.

FIG. 8 illustrates a block diagram of a communications manager that supports scheduling for frequency bands associated with a first band changing capability after a transmit chain switch in accordance with one or more aspects of the present disclosure.

FIG. 9 illustrates a diagram of a system including a device that supports scheduling for frequency bands associated with a first band changing capability after a transmit chain switch in accordance with one or more aspects of the present disclosure.

FIGS. 10 and 11 illustrate block diagrams of devices that support scheduling for frequency bands associated with a first band changing capability after a transmit chain switch in accordance with one or more aspects of the present disclosure.

FIG. 12 illustrates a block diagram of a communications manager that supports scheduling for frequency bands associated with a first band changing capability after a transmit chain switch in accordance with one or more aspects of the present disclosure.

FIG. 13 illustrates a diagram of a system including a device that supports scheduling for frequency bands associated with a first band changing capability after a transmit chain switch in accordance with one or more aspects of the present disclosure.

FIGS. 14 through 18 illustrate flowcharts showing methods that support scheduling for frequency bands associated with a first band changing capability after a transmit chain switch in accordance with one or more aspects of the present disclosure.

### DETAILED DESCRIPTION

In some wireless communications systems, a user equipment (UE) may transmit uplink messages on one or more frequency bands using one or two radio frequency (RF) chains, which may be referred to as transmit chains herein. A network entity may transmit scheduling information to schedule communications by the UE on the one or more frequency bands at a given time. The UE may map the transmit chains to the one or two scheduled frequency bands to perform uplink transmissions. The UE may report capability information that indicates switching time periods for different source and target band pairs. For example, the UE may indicate a first switching time period for the UE to switch between a first frequency band and a second frequency band and a second switching time period for the UE to switch between the first frequency band and a third frequency band. When the network entity schedules a switch from a source frequency band to a target frequency band, the network entity may refrain from scheduling transmissions by the UE for at least the reported switching time period associated with the source and target band pair. The UE may perform one or more transmit chain switches during the switching time period to support communications on the scheduled bands after the switching time period.

In some cases, the UE may transmit capability information that indicates one or more frequency bands that support a first band changing capability, which may be referred to as an unchanged band capability. The first band changing capability may indicate that the UE will maintain a first transmit chain mapped to the corresponding frequency band while performing switches between other frequency bands using a second transmit chain. In such cases, the network entity may schedule continuous communications by the UE on the unchanged band even if other band changes are scheduled during the continuous communications. In some cases, the network entity may schedule a switch from one or two source bands to one or two target bands at a same time, such that the UE needs to switch both transmit chains.

Techniques, systems, and devices described herein define protocols (e.g., a scheduling rule) for scheduling transmissions by a UE after the UE performs two transmit chain switches that are associated with different switching time periods. The scheduling rule may indicate whether transmission is allowed by the UE during a conditional transmission time that is after completion of a first transmit chain switch (associated with a shorter switching time period) between a first source and target band pair and before completion of a second transmit chain switch (associated with a longer switching time period) between a second source and target band pair based on whether the corresponding bands support the first band changing capability.

If a source band and a target band of the first source and target band pair associated with the first (shorter) switching time period support the first band changing capability, transmission by the UE may be permitted during the conditional transmission time after the first switch is complete and before the second switch is complete. For example, the network entity may schedule transmissions by the UE during the conditional transmission time on the target band of the first band pair (e.g., one-port transmissions). The UE may use the first transmit chain to perform the scheduled transmission while completing the second switch of the second transmit chain between the other source and target bands. If only one source band or one target band, or no bands, associated with the first and second switches support the first band changing capability, transmission by the UE may not be permitted during the conditional time period. That is, the UE may not be scheduled for transmissions until after both the first and second switches are complete. The scheduling rule may thereby define some situations in which transmissions are allowed by the UE during the conditional transmission time, which may improve throughput, improve coordination between devices, and reduce latency as compared with systems in which the network entity always refrains from scheduling transmissions during both band switches.

Aspects of the disclosure are initially described in the context of wireless communications systems. Additional aspects of the disclosure are described with reference to band switching timelines and a process flow. Aspects of the disclosure are further illustrated by and described with reference to apparatus diagrams, system diagrams, and flowcharts that relate to scheduling for frequency bands associated with a first band changing capability after a transmit chain switch.

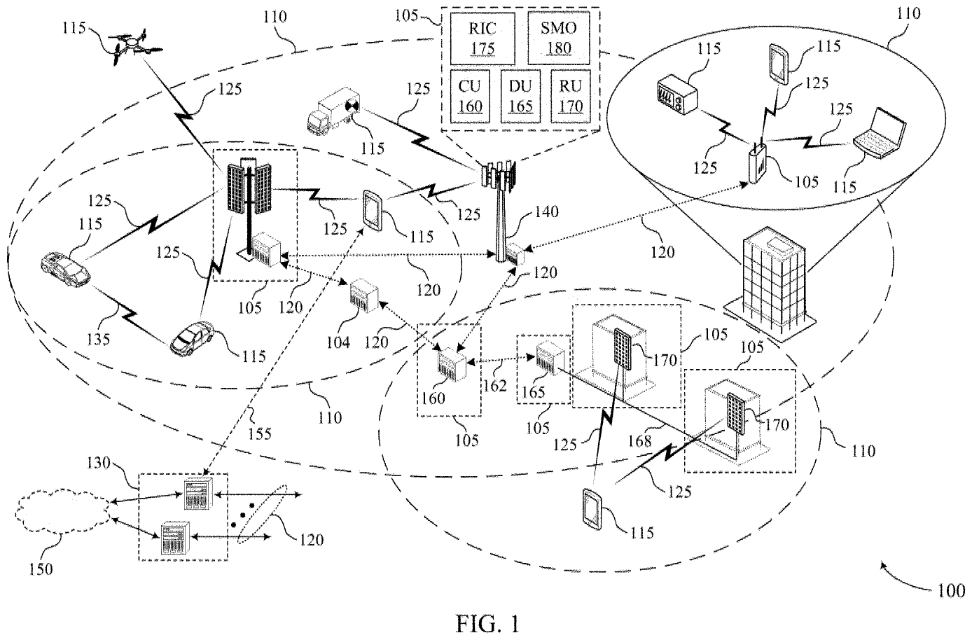

FIG. 1 illustrates an example of a wireless communications system 100 that supports scheduling for frequency bands associated with a first band changing capability after a transmit chain switch in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol).

Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN.

Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support scheduling for frequency bands associated with a first band changing capability after a transmit chain switch as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IOT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IOT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 in the wireless communications system 100 may transmit uplink messages on one or more frequency bands using one or two RF chains, which may be referred to as transmit chains herein. A network entity 105 may transmit scheduling information to schedule communications by the UE 115 on the one or more frequency bands at a given time. The UE 115 may map the transmit chains to the one or two scheduled frequency bands to perform uplink transmissions. The UE 115 may report capability information that indicates switching time periods for different source and target band pairs. For example, the UE 115 may indicate a first switching time period for the UE 115 to switch between a first frequency band and a second frequency band and a second switching time period for the UE 115 to switch between the first frequency band and a third frequency band. When the network entity 105 schedules a switch from a source frequency band to a target frequency band, the network entity 105 may refrain from scheduling transmissions by the UE 115 for at least the reported switching time period associated with the source and target band pair. The UE 115 may perform one or more transmit chain switches during the switching time period to support communications on the scheduled bands after the switching time period.

In some cases, the UE 115 may transmit capability information that indicates one or more frequency bands that support a first band changing capability, which may be referred to as an unchanged band capability. The first band changing capability may indicate that the UE 115 will maintain a first transmit chain mapped to the corresponding frequency band while performing switches between other frequency bands using a second transmit chain. In such cases, the network entity 105 may schedule continuous communications by the UE 115 on the unchanged band even if other band changes are scheduled during the continuous communications. In some cases, the network entity 105 may schedule a switch from one or two source bands to one or two target bands at a same time, such that the UE 115 needs to switch both transmit chains.

Techniques, systems, and devices described herein define a scheduling rule for scheduling uplink transmissions by a UE 115 after the UE 115 is scheduled to switch from one or two source frequency bands to one or two target frequency bands, where the scheduling rule may be based on whether the source and target frequency bands support a first band changing capability. The UE 115 may transmit first capability information that indicates at least a first frequency band is associated with the first band changing capability. The UE 115 may transmit second capability information (e.g., together with or separate from the first capability information) that indicates a first switching time period and a second switching time period supported by the UE 115. The first switching time period may pertain to a first switch, by the UE 115, between the first frequency band and a second frequency band, and the second switching time period may pertain to a second switch, by the UE 115, between a third frequency band and the second frequency band. In some examples, the second switching time period may be longer than the first switching time period.

The UE 115 may receive, from a network entity 105, scheduling information that schedules a change between communications by the UE 115 on a band pair, that includes the first and third frequency bands, and communications by the UE 115 on the second frequency band. The UE 115 may switch between the band pair and the second frequency band based on the scheduling information. The switching may include a first switch during the first switching time period and a second switch during the second switching time period, where the first and second switching time periods overlap in time. The network entity 105 may schedule a transmission by the UE 115 based on the reported capability information and the scheduling rule. For example, the network entity 105 may schedule the UE 115 to transmit an uplink message after at least a portion of the switching. The scheduling rule may define whether the transmission is permitted during a conditional transmission time that is after the first switching time period is complete and before the second switching time period is complete. The UE 115 may transmit the message accordingly. The described scheduling rule may thereby define protocols for scheduling uplink transmissions after a UE 115 performs two transmit chain switches, which may improve throughput, improve coordination between devices, and reduce latency.

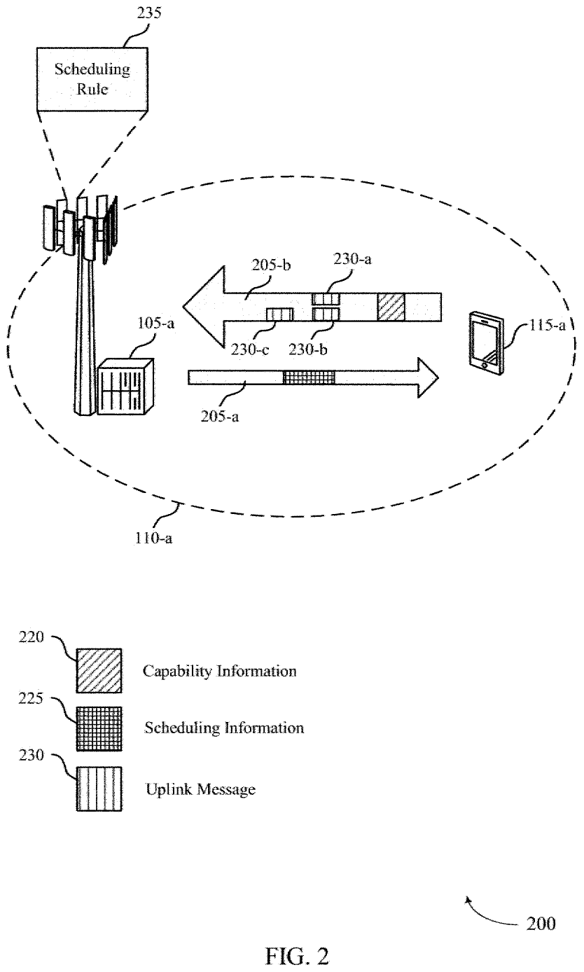

FIG. 2 illustrates an example of a wireless communications system 200 that supports scheduling for frequency bands associated with a first band changing capability after a transmit chain switch in accordance with one or more aspects of the present disclosure. The wireless communications system 200 may include a network entity 105-a and a UE 115-a, which may represent examples of a network entity 105 and a UE 115 as described with reference to FIG. 1. The network entity 105-a and the UE 115-a may communicate within a geographic coverage area 110-a. The network entity 105-a may communicate with the UE 115-a via one or more downlink communication links 205-a and one or more uplink communication links 205-b.

The wireless communications system 200 may support communications between the UE 115-a and the network entity 105-a using one or more frequency bands (e.g., component carriers). For example, the UE 115-a may transmit uplink messages 230 to the network entity 105-a via one or more frequency bands in a TDD manner, or an FDD manner, or both. In some examples, the uplink communication link 205-a may include multiple frequency bands. Additionally, or alternatively, each uplink communication link 205-a may be associated with or may include a respective frequency band.

The UE 115-a may be configured with a first quantity of RF chains (e.g., two RF chains), which may each include circuitry or components configured to generate and transmit a signal at the UE 115-a. An RF chain may, in some examples, be referred to as a transmit chain (or a receive chain in case of reception at the UE 115-a). A quantity of antenna ports at the UE 115-a may be the same as or different than the quantity of RF chains. A single RF chain may be used to generate a signal for transmission from a single antenna port (e.g., a one-to-one mapping for each transmission). The UE 115-a may transmit a total quantity of simultaneous transmissions that may not exceed a quantity of RF chains at the UE 115-a.

The UE 115-a may switch transmit chains at the UE 115-a between different frequency bands based on scheduling information 225 received from the network entity 105-a. The scheduling information 225 may be, for example, a grant or other message that allocates time and frequency resources for uplink transmissions by the UE 115-a.

The network entity 105-a may schedule the UE 115-a to transmit on one or two frequency bands at a given time, and the UE 115-a may perform the transmit chain mapping to the scheduled frequency bands.

For example, the scheduling information 225 may allocate resources for transmission, by the UE 115-a, of the message 230-a on a first frequency band and the message 230-b on a second frequency band at a same time. The UE 115-a may adjust the transmit chains at the UE 115-a such that a first transmit chain is mapped to the first frequency band and a second transmit chain is mapped to the second frequency band at the scheduled time, and the UE 115-a may perform a one-port transmission on each frequency band to transmit the two messages 230-a and 230-b. The scheduling information 225 may subsequently allocate resources on the second frequency band for transmission, by the UE 115-a, of the message 230-c at a second time. The UE 115-b may switch the first transmit chain from the first frequency band to the second frequency band, and the UE 115-a may perform a one-port or two-port transmission using one or both transmit chains on the second frequency band at the scheduled time to transmit the message 230-c. In this example, no direct scheduling from the network entity 105-a indicates a change to the second frequency band (e.g., there are communications scheduled on the second frequency band before and after the switch). However, the other scheduled change from the first frequency band to the second frequency band may indirectly affect the second frequency band mapping. For example, the UE 115-a may perform one or more transmit chain switches to be able to transmit using both transmit chains on the second frequency band at the scheduled time, where the one or more transmit chain switches may include a switch of the first transmit chain, the second transmit chain, or both, in some examples (e.g., the UE 115-a may or may not take actions on the second frequency band to support the switch from the first frequency band).

The UE 115-a may transmit capability information 220 that indicates one or more switching time periods supported by the UE 115-a. The capability information 220 may be a capability message (e.g., an RRC message, a medium access control-control element (MAC-CE), uplink control information (UCI), or some other type of capability signaling) transmitted via one or more frequency bands of the uplink communication link 205-b. A switching time period may represent a duration of time that the UE 115-a may take to switch transmit chains from a first (source) frequency band to a second (target) frequency band in response to the scheduling information 225 indicating a switch between a source and target band pair. The capability information 220 may indicate a set of one or more switching time periods each associated with a respective source and target band pair.

In some cases, if the network entity 105-a schedules a switch between a source frequency band and a target frequency band, the network entity 105-a may refrain from scheduling transmissions by the UE 115-a during a gap time period that is based on (e.g., greater than or equal to) the switching time period reported by the UE 115-a for the corresponding source and target band pair. The UE 115-a may perform transmit chain switching during the gap time period and may perform uplink transmissions on the scheduled target band after the gap time period.

In some examples, the network entity 105-a may schedule the UE 115-a to switch from one source band to two target bands, where one of the target bands is the same as the source, or from two source bands to one target band, where one of the source bands is the same as the target band. That is, the network entity 105-a may schedule a switch between one frequency band and a band pair, where the one frequency band is scheduled before and after the switch. In some cases, the network entity 105-a may refrain from scheduling transmissions by the UE 115-a during a switching time period associated with a switch between the one frequency band and the other frequency band of the band pair. However, to improve throughput as described herein, the network entity 105-a may schedule transmissions on the constant or unchanged frequency band during the switch between the constant frequency band and the other frequency band of the band pair if the constant frequency band is associated with a first band changing capability.

The UE 115-a may report whether one or more bands are associated with the first band changing capability via the capability information 220. The UE 115-a may transmit first capability information 220 (e.g., a first capability message) that indicates the switching time periods and the UE 115-a may transmit second capability information 220 (e.g., a second capability message) that indicates the first band changing capability, or the UE 115-a may transmit the switching time periods and the first band changing capability indications via the same capability information 220. The first band changing capability may be referred to as an unchanged band capability, and a frequency band that is associated with the first band changing capability may be referred to as an unchanged band, in some examples herein. If the UE 115-a reports that a frequency band is associated with (e.g., supports) the first band changing capability, the UE 115-a may indicate that the UE 115-a will maintain a mapping between a transmit chain of the UE 115-a and the unchanged band while performing switches between other bands using a different transmit chain of the UE 115-a. That is, the first band capability may allow uplink transmissions on the band with the quantity of transmit chains unchanged. The unchanged transmit chain may be expected to be capable of transmission during another transmit chain switch.

In some cases, the unchanged band may also be scheduled for a switch. For example, the network entity 105-a may schedule the UE 115-a to switch between one or two source bands to one or two target bands, where the one or two target bands are different than the one or two source bands. The UE 115-a may switch both transmit chains of the UE 115-a to support such a scheduled band switch. In some examples, a first switching time period for switching a first transmit chain may be different than a second switching time period for switching a second transmit chain as part of the scheduled band switch.

To reduce ambiguity and transmit chain outage in scenarios in which the UE 115-a is scheduled to perform two transmit chain switches associated with different switching periods, a scheduling rule 235 for scheduling uplink transmissions by the UE 115-a is defined herein. The scheduling rule 235 may define whether transmissions by the UE 115-a are allowed during a conditional transmission time that is after a first transmit chain switch is complete but before a second transmit chain switch is complete. The scheduling rule 235 may be a configuration or protocol configured at the network entity 105-a and the UE 115-a, may be indicated via control signaling exchanged between the UE 115-a and the network entity 105-a, may be associated with a defined scheduling behavior by the devices (e.g., defined in a standard), or any combination thereof.

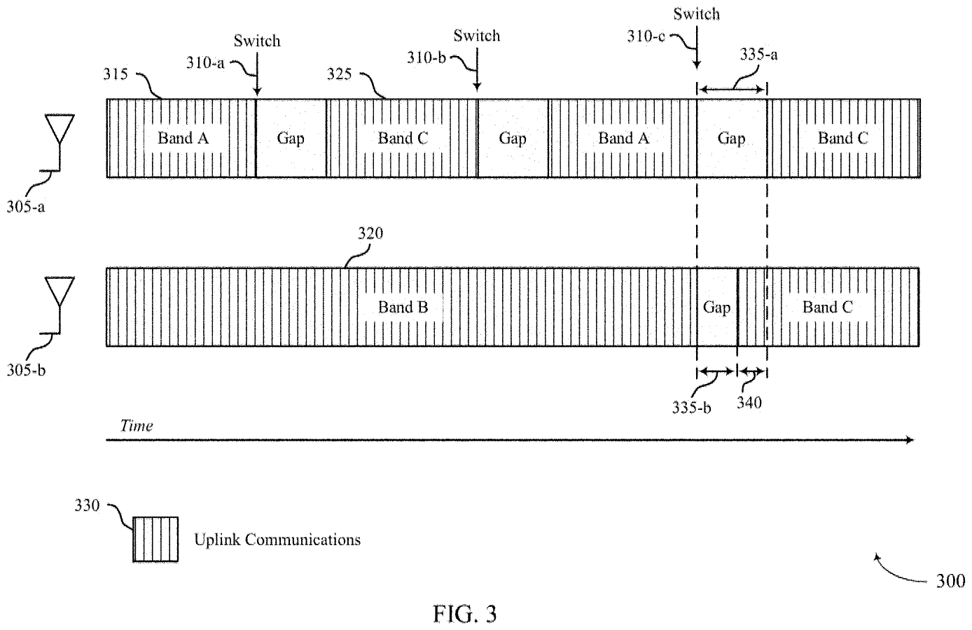

The scheduling rule 235 may permit transmissions by the UE 115-a during the conditional time period after a first transmit chain switch is complete and before a second transmit chain switch is complete if the first (shorter) transmit chain switch is associated with a switch between two frequency bands that support the first band changing capability (e.g., two unchanged bands). As such, if the network entity 105-a schedules a switch between one or two source bands and one or two target bands, and at least one source and one target band pair are reported to be associated with the first band changing capability and a shorter switching time period than a second switching time period pertaining to a second source and target band pair, the network entity 105-a may schedule an uplink message 230 for transmission by the UE 115-a during the conditional time period (e.g., before the second switching time period is complete), as described in further detail elsewhere herein, including with reference to FIG. 3. Such scheduling techniques may improve throughput and reduce latency, as the UE 115-a may perform a one port transmission using the switched transmit chain sooner than if the network entity 105-a refrains from scheduling the uplink message 230 until after both switches are complete.

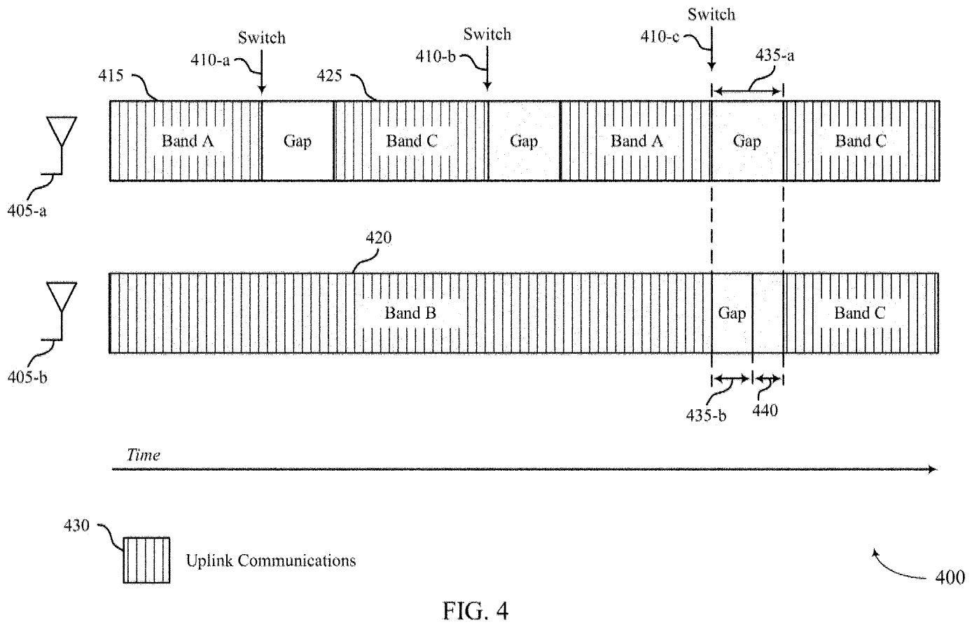

The scheduling rule 235 may not permit transmissions by the UE 115-a during the conditional time period after a first transmit chain switch is complete and before a second transmit chain switch is complete if one or zero frequency bands of a set of frequency bands involved in the band switch are associated with the first band changing capability. For example, if the network entity 105-a schedules a switch from a first frequency band to a target band pair including a second frequency band and a third frequency band, the set of frequency bands involved in the switch may include the first, second, and third frequency bands. If none of the frequency bands support the first band changing capability, the scheduling rule 235 may not permit transmissions by the UE 115-a during the conditional time period. If only one of the frequency bands support the first band changing capability, the scheduling rule 235 may not permit transmissions by the UE 115-a during the conditional time period, as described in further detail elsewhere herein, including with reference to FIG. 4.

The scheduling rule 235 described herein may thereby reduce ambiguity and improve coordination between devices by defining protocols for scheduling uplink transmissions by a UE 115 after the UE 115 is scheduled to perform two transmit chain switches associated with different switching time periods based on band changing capabilities of the frequency bands involved in the switch. By permitting the UE 115 to perform uplink transmissions during a conditional time period if a first switch between two bands supporting the first band changing capability is complete, the scheduling rule 235 may support improved throughput and reduced latency. Moreover, not permitting transmissions during the conditional time period if one or zero frequency bands support the first band changing capability may ensure that the communications by the UE 115 are reliable and accurate, which may improve reliability, throughput, and coordination between devices.

FIG. 3 illustrates an example of a band switching timeline 300 that supports scheduling for frequency bands associated with a first band changing capability after a transmit chain switch in accordance with one or more aspects of the present disclosure. The band switching timeline 300 may implement or be implemented by aspects of the wireless communications systems 100 and 200 as described with reference to FIGS. 1 and 2. For example, the band switching timeline 300 illustrates a timeline for uplink communications 330 by a UE 115 on two or more frequency bands (e.g., component carriers) using two transmit chains 305 of the UE 115. The uplink communications 330 and corresponding frequency bands may be scheduled via scheduling information transmitted by a network entity 105. The network entity 105 and the UE 115 may represent examples of corresponding devices as described with reference to FIGS. 1 and 2. In this example, the network entity 105 may schedule the uplink communications 330 based on a scheduling rule as described herein.

The UE may transmit first capability information that indicates one or more switching time periods 335 supported by the UE, as described with reference to FIG. 2. For example, the UE 115 may indicate, via the first capability information, that the UE 115 may support a first switching time period 335-a and a second switching time period 335-b. The first switching time period 335-a may represent a duration of time that the UE 115 needs to perform a switch between a first band 315 (band A) and a third band 325 (band C). The second switching time period 335-b may represent a duration of time that the UE 115 needs to perform a switch between a second band 320 (band B) and the third band 325. In this example, the second switching time period 335-b may be shorter than the first switching time period 335-a. For example, the first switching time period 335-a may be 140 microseconds, or some other duration, and the second switching time period 335-b may be 35 microseconds, or some other duration.

The UE 115 may transmit second capability information that indicates one or more bands that support a first band changing capability. The first and second capability information may be transmitted via a same capability message or different capability messages. In this example, the UE 115 may report that a second band 320 and a third band 325 support the first band changing capability. By indicating that the second band 320 and the third band 325 support the first band changing capability (e.g., are unchanged bands), the UE 115 may indicate that if the network entity 105 schedules a change between communications on two source bands and communications on two target bands, and at least one of the second band 320 or the third band 325 is included in the source and target bands, the UE 115 will maintain a mapping between a transmit chain 305 and the corresponding unchanged band (e.g., the second band 320 or the third band 325) while performing a switch between the other source and target band pair using a different transmit chain 305 of the UE 115. The network entity 105 may thereby schedule continuous transmissions by the UE 115 on the unchanged band during other band switches.

With reference to FIG. 3, the network entity 105 may schedule communications by the UE 115 on a first band 315 and the second band 320 during a first time period. The UE 115 may map the transmit chains 305-a and 305-b to the first band 315 and the second band 320, respectively, to perform the communications. The network entity 105 may not know how the UE 115 maps the transmit chains 305 to the bands. The network entity 105 may subsequently schedule a first switch 310-a to communications on the third band 325 and the second band 320. That is, the network entity 105 may schedule a switch 310-a between two source bands and two target bands (e.g., band A and band B to band C and band B), and the second band 320 may be included in both the source and target bands (e.g., may be unchanged). The UE 115 may adjust the transmit chain mapping to support the communications on the third band 325 and the second band 320. The network entity 105 may refrain from scheduling uplink communications 330 by the UE 115 on the first band 315 or the third band 325 during a gap time period that is based on (e.g., greater than or equal to) the first switching time period 335-a, as reported by the UE 115 via the capability information, for switching between the first frequency band 315 and the third frequency band 325.

In this example, because the UE 115 reported that the second band 320 is associated with the first band changing capability, the network entity 105 may assume that the UE 115 will maintain a mapping of a transmit chain 305 of the UE 115 (e.g., the transmit chain 305-b) and the second band 320 during the other scheduled switch between the first band 315 and the third band 325. Accordingly, the network entity 105 may schedule continuous uplink communications 330 by the UE 115 on the second band 320 even during the gap time for the switch from the first band 315 to the third band 325. The UE 115 may use the transmit chain 305-b to perform the continuous uplink communications 330 on the second band 320 while the UE 115 switches the transmit chain 305-a from the first band 315 to the third band 325.

The network entity 105 may subsequently schedule a second switch 310-b from communications on the third band 325 and the second band 320 to communications on the first band 315 and the second band 320. The network entity 105 may similarly refrain from scheduling uplink communications 330 during the gap time period that is greater than or equal to the first switching time period 335-a for switching between the first band 315 and the third band 325, and the network entity 105 may schedule continuous uplink communications 330 on the second band 320 based on the second band 320 supporting the first band changing capability.

In some cases, the network entity 105 may schedule a switch 310 from one or two source bands to one or two target bands that are different than the source bands. That is, the network entity 105 may schedule a band switch 310 without a constant or unchanged band. In such cases, the UE 115 may need to switch both transmit chains 305-a and 305-b at the same time. In some aspects, the switching time periods 335 associated with both transmit chain switches may not be the same. Techniques, systems, and devices described herein define a scheduling rule for scheduling uplink communications 330 by a UE 115 after the UE 115 performs two transmit chain switches that are associated with different switching time periods 335. The scheduling rule may define whether transmission is allowed by the UE 115 during a conditional transmission time 340 between completion of the shorter switching time period 335 and completion of the longer switching time period 335.

In the example of FIG. 3, the network entity 105 may schedule a switch 310-c from uplink communications 330 on the first band 315 and the second band 320 to uplink communications 330 on the third band 325 (e.g., a two-port transmission on the band C). The UE 115 may switch the transmit chain 305-a from the first band 315 to the third band 325 during the first switching time period 335-a and the UE 115 may switch the transmit chain 305-b from the second band 320 to the third band 325 during the switching time period 335-b based on the scheduled switch 310-c. The first switching time period 335-a and the second switching time period 335-b may be overlapping in time. In some examples, the first switching time period 335-a and the second switching time period 335-b may start at a same time (e.g., at a first time when the switch 310-c is scheduled). The first switching time period 335-a may be longer than the second switching time period 335-b. As such, there may be a conditional transmission time 340 between completion of the switch of the transmit chain 305-b from the second band 320 to the third band 325 during the second switching time period 335-b and completion of the switch of the transmit chain 305-a from the first band 315 to the third band 325 during the first switching time period 335-a.

As described herein, the scheduling rule may define that transmission is allowed by the UE 115 during the conditional transmission time 340 if the shorter switching time period (e.g., the switching time period 335-b in FIG. 3) is associated with a switch between two bands that support the first band changing capability (e.g., one source and one target band pair are reported as unchanged bands). As such, the network entity 105 may be permitted to schedule uplink communications 330 by the UE 115 during the conditional transmission time 340 in the example of FIG. 3 because the switching time period 335-b may be associated with a switch between the second band 320 and the third band 325, which are both associated with the first band changing capability in this example. The network entity 105 may schedule the uplink communications 330 as a one-port transmission on the third band 325 during the conditional transmission time 340. The UE 115 may transmit an uplink message using the transmit chain 305-b mapped to the third frequency band 325 during the conditional transmission time 340 based on the scheduling information from the network entity 105.

The network entity 105 may refrain from scheduling uplink communications 330 by the UE 115 on the first band 315 or two-port uplink communications 330 on the third band 325 for at least the first switching time period 335-a while the UE 115 completes the first switch of the transmit chain 305-a from the first band 315 to the third band 325. The network entity 105 may schedule second uplink communications 330 as two-port transmissions by the UE 115 on the third band 325 after the conditional transmission time 340 (e.g., after completion of the switching time period 335-a). Additionally, or alternatively, the UE 115 may continue the one-port transmission using the transmit chain 305-b on the third frequency band 325 after the conditional transmission time 340.

Although the third switch 310-c is illustrated as a switch from a source band pair including the first frequency band 315 and the second frequency band 320 to the third frequency band 325 (a single target band), it is to be understood that the scheduling rule may apply for other switches from a single source band to two target bands. For example, if the network entity 105 schedules a switch 310 from the uplink communications 330 on the third band 325 to uplink communications 330 on the first band 315 and the second band 320, the first switching time period 335-a and the second switching time periods 335-b may still apply, and there may be a similar conditional transmission time 340. The scheduling rule may still permit transmissions by the UE 115 during the conditional transmission time if at least one source and target band pair are both associated with the first band changing capability. For example, the UE 115 may transmit on the second frequency band 320 using the transmit chain 305-b after the UE 115 completes a switch from the third band 325 to the second band 320 and before the UE 115 completes a switch from the third band 325 to the first band 315 using the transmit chain 305-a.

The scheduling rule described herein may thereby define whether the UE 115 is permitted to perform uplink communications 330 during a conditional transmission time 340 when the UE 115 is scheduled to perform two transmit chain switches associated with two different switching time periods 335. By permitting uplink communications 330 when at least one of the transmit chain switches is between two bands that support the first band changing capability, the scheduling rule may leverage the capability of the UE 115 to transmit during other band switches to provide for improved throughput and reduced latency as compared with systems in which the network entity 105 waits until after the longer switching time period 335 to schedule the uplink communications 330.

FIG. 4 illustrates an example of a band switching timeline 400 that supports scheduling for frequency bands associated with a first band changing capability after a transmit chain switch in accordance with one or more aspects of the present disclosure. The band switching timeline 400 may implement or be implemented by aspects of the wireless communications systems 100 and 200 or the band switching timeline 300, as described with reference to FIGS. 1-3. For example, the band switching timeline 400 illustrates a timeline for uplink communications 430 by a UE 115 on two or more frequency bands (e.g., component carriers) using two transmit chains 405 of the UE 115. The uplink communications 430 and corresponding frequency bands may be scheduled via scheduling information transmitted by a network entity 105. The network entity 105 and the UE 115 may represent examples of corresponding devices as described with reference to FIGS. 1-3. In this example, the network entity 105 may schedule the uplink communications 430 based on a scheduling rule as described herein.

The UE 115 may transmit first capability information that indicates one or more switching time periods 435 supported by the UE 115, as described with reference to FIG. 2. For example, the UE 115 may indicate, via the first capability information, that the UE 115 may support a first switching time period 435-a and a second switching time period 435-b. The first switching time period 435-a may represent a duration of time that the UE 115 needs to perform a switch between a first band 415 (band A) and a third band 425 (band C). The second switching time period 435-b may represent a duration of time that the UE 115 needs to perform a switch between a second band 420 (band B) and the third band 425. In this example, the second switching time period 435-b may be shorter than the first switching time period 435-a. The first and second switching time periods 435-a and 435-b may represent examples of the switching time periods 335-a and 335-b described with reference to FIG. 3.

The UE 115 may transmit second capability information that indicates one or more bands that support a first band changing capability. The first and second capability information may be transmitted via a same capability message or different capability messages. In this example, the UE 115 may report that a second band 420 supports the first band changing capability. By indicating that the second band 420 supports the first band changing capability (e.g., is an unchanged band), the UE 115 may indicate that if the network entity 105 schedules a change between communications on two source bands and communications on two target bands, and the second band 420 is included in both the source and target bands, the UE 115 will maintain a mapping between a transmit chain 405 and the corresponding unchanged band (e.g., the second band 420) while performing a switch between the other source and target band pair using a different transmit chain 405 of the UE 115. The network entity 105 may thereby schedule continuous transmissions by the UE 115 on the unchanged band during other band switches.

With reference to FIG. 4, the network entity 105 may schedule communications by the UE 115 on a first band 415 and the second band 420 during a first time period. The UE 115 may map the transmit chains 405-a and 405-b to the first band 415 and the second band 420, respectively, to perform the communications. The network entity 105 may subsequently schedule a first switch 410-a to communications on the third band 425 and the second band 420. That is, the network entity 105 may schedule a switch 410-a between two source bands and two target bands (e.g., band A and band B to band C and band B), and the second band 420 may be included in both the source and target bands (e.g., may be unchanged).

As described in further detail elsewhere herein, including with reference to FIG. 3, because the UE 115 reported that the second band 420 is associated with the first band changing capability, the network entity 105 may assume that the UE 115 will maintain a mapping of a transmit chain 405 of the UE 115 (e.g., the transmit chain 405-b) and the second band 420 during the other scheduled switch between the first band 415 and the third band 425. Accordingly, the network entity 105 may schedule continuous uplink communications 430 by the UE 115 on the second band 420 even during the gap time for the switch from the first band 415 to the third band 425. The UE 115 may use the transmit chain 405-b to perform the continuous uplink communications 430 on the second band 420 while the UE 115 switches the transmit chain 405-a from the first band 415 to the third band 425.

The network entity 105 may subsequently schedule a second switch 410-b from communications on the third band 425 and the second band 420 to communications on the first band 415 and the second band 420. The network entity 105 may similarly refrain from scheduling uplink communications 430 on the first band 415 or the third band 425 during the gap time period that is greater than or equal to the first switching time period 435-a for switching between the first band 415 and the third band 425, and the network entity 105 may schedule continuous uplink communications 430 on the second band 420 based on the second band 420 supporting the first band changing capability.

In some cases, the network entity 105 may schedule a switch 410 from one or two source bands to one or two target bands that are different than the source bands. That is, the network entity 105 may schedule a band switch 410 without a constant or unchanged band. In such cases, the UE 115 may need to switch both transmit chains 405-a and 405-b at the same time. In some aspects, the switching time periods 435 associated with both transmit chain switches may not be the same. Techniques, systems, and devices described herein define a scheduling rule for scheduling uplink communications 430 by a UE 115 after the UE 115 performs two transmit chain switches that are associated with different switching time periods 435. The scheduling rule may define whether transmission is allowed by the UE 115 during a conditional transmission time 440 between completion of the shorter switching time period 435 and completion of the longer switching time period 435.

In the example of FIG. 4, the network entity 105 may schedule a switch 410-c from uplink communications 430 on the first band 415 and the second band 420 to uplink communications 430 on the third band 325 (e.g., a two-port transmission on the band C). To perform the scheduled switch 410-c, the UE 115 may perform a first switch using the first transmit chain 405-a and a second switch using the second transmit chain 405-b. To perform the first switch, the UE 115 may switch the transmit chain 405-a from the first band 415 to the third band 425 during the first switching time period 435-a. To perform the second switch, the UE 115 may switch the transmit chain 405-b from the second band 420 to the third band 425 during the switching time period 435-b. The first switching time period 435-a and the second switching time period 435-b may be overlapping in time. In some examples, the first switching time period 435-a and the second switching time period 435-b may start at a same time (e.g., at a first time when the switch 410-c is scheduled). The first switching time period 435-a may be longer than the second switching time period 435-b. As such, there may be a conditional transmission time 440 between completion of the switch of the transmit chain 405-b from the second band 420 to the third band 425 during the second switching time period 435-b and completion of the switch of the transmit chain 405-a from the first band 415 to the third band 425 during the first switching time period 435-a.

As described herein, the scheduling rule may define that transmission is not allowed by the UE 115 during the conditional transmission time 440 if only one of the source and target bands, or none of the bands associated with the switch, are associated with the first band changing capability. A set of frequency bands associated with a switch may include each target band and each source band. In the example of FIG. 4, the set of bands associated with the switch 410-c may include the first band 415, the second band 420, and the third band 425. In this example, the UE 115 may have reported that the second band 420 is associated with the first band changing capability. However, the first band 415 and the third band 425 may not be associated with the first band changing capability. Accordingly, because there is not a pair of a source band and a target band that both support the first band changing capability, the scheduling rule may indicate that transmissions by the UE 115 are not permitted during the conditional transmission time 440.

Accordingly, the network entity 105 may refrain from scheduling uplink communications 430 during the conditional transmission time 440 on any of the bands. The network entity 105 may instead wait until both the first switching time period 435-a and the second switching time period 435-b are complete before scheduling uplink communication 430. The UE 115 may transmit an uplink message on the third frequency band 425 using one or both of the transmit chains 405-a and 405-b (e.g., a one or two-port transmission) after the first switching time period 435-a and the second switching time period 435-b are complete based on the scheduling information from the network entity. The UE 115 may thereby switch the transmit chains 405-a and 405-b in any way to arrive at both transmit chains 405 being mapped to the third frequency band 425 for transmission after the switching time periods 435.

Although the third switch 410-c is illustrated as a switch from a source band pair including the first frequency band 415 and the second frequency band 420 to the third frequency band 425 (a single target band), it is to be understood that the scheduling rule may apply for other switches from a single source band to two target bands. For example, if the network entity 105 schedules a switch 410 from the uplink communications 430 on the third band 425 to uplink communications 430 on the first band 415 and the second band 420, the first switching time period 435-a and the second switching time period 435-b may still apply, and there may be a similar conditional transmission time 440. The scheduling rule may still not permit transmissions by the UE 115 during the conditional transmission time 440 if only one band or no bands of the source and target bands are both associated with the first band changing capability.

The scheduling rule described herein may thereby define whether the UE 115 is permitted to perform uplink communications 430 during a conditional transmission time 440 when the UE 115 is scheduled to perform two transmit chain switches associated with two different switching time periods 435. By not permitting uplink communications 430 when one or fewer bands associated with the switch support the first band changing capability, the scheduling rule may ensure the UE 115 has sufficient time to switch transmit chains 405 before performing uplink communications 430, which may improve reliability, throughput, and coordination between devices.

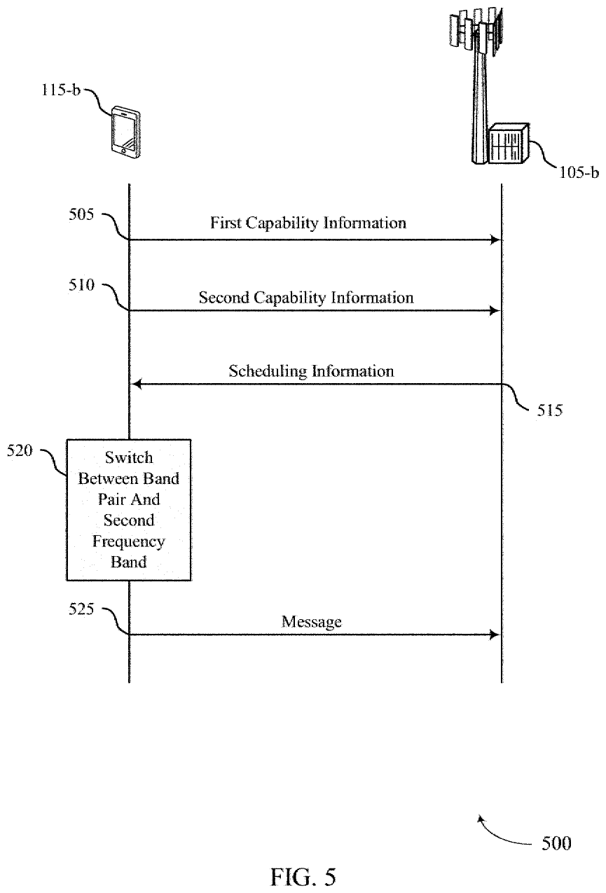

FIG. 5 illustrates an example of a process flow 500 that supports scheduling for frequency bands associated with a first band changing capability after a transmit chain switch in accordance with one or more aspects of the present disclosure. The process flow 500 may implement or be implemented by aspects of the wireless communications systems 100 and 200 or the band switching timelines 300 and 400, described with reference to FIGS. 1-4. For example, the process flow 500 illustrates communications between a network entity 105-b and a UE 115-b, which may represent aspects of corresponding devices as described with reference to FIGS. 1-4. In this example, the network entity 105-b may schedule communications by the UE 115-b on one or more frequency bands based on a scheduling rule.

In the following description of the process flow 500, the operations between the network entity 105-b and the UE 115-b may be performed in different orders or at different times. Some operations may also be left out of the process flow 500, or other operations may be added. Although the network entity 105-b and the UE 115-b are shown performing the operations of the process flow 500, some aspects of some operations may also be performed by one or more other wireless devices.

At 505, the UE 115-b may transmit, to the network entity 105-b, first capability information that indicates at least a first frequency band is associated with a first band changing capability. The first band changing capability may indicate the UE 115-b will maintain a mapping between a first transmit chain of the UE 115-b and the first frequency band while performing other scheduled frequency band switches using a second transmit chain of the UE 115-b, as described in further detail elsewhere herein, including with reference to FIGS. 1-4. In some examples, the first capability information may indicate a second frequency band is associated with the first band changing capability.

At 510, the UE 115-b may transmit, to the network entity 105-b, second capability information that indicates a first switching time period and a second switching time period supported by the UE 115-b. The first switching time period may pertain to a first switch, by the UE 115-b, between the first frequency band and the second frequency band. The second switching time period may pertain to a second switch, by the UE 115-b, between a third frequency band and the second frequency band. The second switching time period may be longer than the first switching time period. The first and second switching time periods may represent examples of the switching time periods 335 and 435, as described with reference to FIGS. 3 and 4. In some examples, the first capability information and the second capability information may be transmitted via a single capability message. Additionally, or alternatively, the first and second capability information may be transmitted via separate capability messages or other signaling.

At 515, the network entity 105-b may transmit, to the UE 115-b, scheduling information that schedules a change between communications by the UE 115-b on a band pair and communications by the UE 115-b on the second frequency band. The band pair may include the first frequency band and the third frequency band. In some examples, the scheduling information may indicate resources that are allocated for transmission, by the UE 115-b, of a message on one or more bands based on the band switch.

At 520, the UE 115-b may switch between the band pair and the second frequency band based on the scheduling information. The switching may include performing the first switch and the second switch, where the first switching time period of the first switch may overlap in time with the second switching time period of the second switch. In some examples, the first switch may include switching the first transmit chain of the UE 115-b between the first frequency band and the second frequency band and the second switch may include switching the second transmit chain of the UE 115-b between the third frequency band and the second frequency band, as described and illustrated with reference to FIGS. 3 and 4.

In some examples, the scheduling information may schedule a change from the band pair to the second frequency band. In such cases, the UE 115-b may switch the first transmit chain from the first frequency band to the second frequency band during the first switching time period and the UE 115-b may switch the second transmit chain from the third frequency band to the second frequency band during the second switching time period. Additionally, or alternatively, the scheduling information may schedule a change from the second frequency band to the band pair. In such cases, the UE 115-b may switch the first transmit chain from the second frequency band to the first frequency band during the first switching time period and the UE 115-b may switch the second transmit chain from the second frequency band to the third frequency band during the second switching time period.

At 525, the UE 115-b may transmit a message to the network entity 105-b after at least a portion of the switching. The UE 115-b may transmit the message in accordance with a scheduling rule that defines whether transmission is allowed during a conditional transmission time that is after completion of the first switching time period and before completion of the second switching time period. In some examples, the network entity 105-b may schedule the transmission of the message by the UE 115-b based on the scheduling rule. For example, the network entity 105-b may transmit, via the scheduling information or second scheduling information, an indication of resources allocated for transmission of the message. The time and frequency resources indicated via the scheduling information may be based on the scheduling rule.

The scheduling rule may define that transmission by the UE 115-b is allowed during the conditional transmission time when the first switch associated with the first (shorter) switching time period is between two frequency bands associated with the first band changing capability (e.g., a target and source band pair including unchanged bands). Thus, if the second frequency band is associated with the first band changing capability, as indicated via the first capability information, the network entity 105-b may schedule the transmission of the message during the conditional transmission time based on the scheduling rule, and the UE 115-b may perform the transmission during the conditional transmission time accordingly, as described with reference to FIG. 3.

The scheduling rule may define that transmission by the UE 115-b is not allowed during the conditional transmission time when only one frequency band of a set of frequency bands is associated with the first band changing capability. The set of frequency bands may include bands associated with the first and second switches, which may include the first, second, and third frequency bands in this example. Thus, if the first frequency band is associated with the first band changing capability, but the second and third frequency bands are not associated with the first band changing capability, the network entity 105-b may refrain from scheduling transmission of the message during the conditional transmission time. The network entity 105-b may instead schedule the transmission of the message after the second switching time period is complete, and the UE 115-b may transmit the message after the second switching time period is complete accordingly, as described with reference to FIG. 4.

The UE 115-b may thereby perform uplink transmissions after switching both transmit chains of the UE 115-b according to the scheduling rule described herein. By determining whether or not to transmit during the conditional transmission time based on the scheduling rule, the devices may support improved coordination, improved throughput, improved reliability and reduced latency as compared with systems in which behavior during the conditional transmission time is undefined or transmissions are scheduled after the longest switching time is complete.

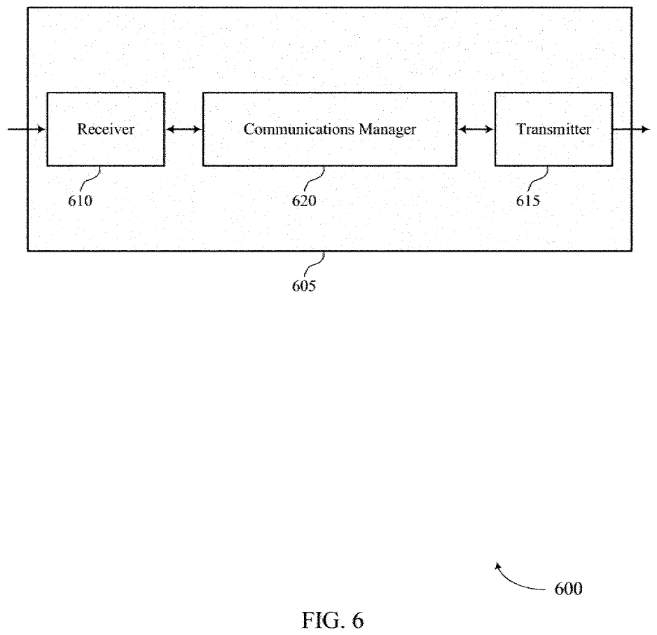

FIG. 6 illustrates a block diagram 600 of a device 605 that supports scheduling for frequency bands associated with a first band changing capability after a transmit chain switch in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to scheduling for frequency bands associated with a first band changing capability after a transmit chain switch). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to scheduling for frequency bands associated with a first band changing capability after a transmit chain switch). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of scheduling for frequency bands associated with a first band changing capability after a transmit chain switch as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

Additionally, or alternatively, the communications manager 620 may support wireless communication at a UE in accordance with examples as disclosed herein. For example, the communications manager 620 may be configured as or otherwise support a means for transmitting first capability information that indicates a first frequency band is associated with a first band changing capability, where the first band changing capability indicates the UE will maintain a mapping between a first transmit chain of the UE and the first frequency band while performing other scheduled frequency band switches using a second transmit chain of the UE. The communications manager 620 may be configured as or otherwise support a means for transmitting second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period. The communications manager 620 may be configured as or otherwise support a means for receiving scheduling information that schedules a change between communications by the UE on a band pair, that includes the first frequency band and the third frequency band, and communications by the UE on the second frequency band. The communications manager 620 may be configured as or otherwise support a means for switching between the band pair and the second frequency band based on the scheduling information, where the switching includes the first switch and the second switch, the first switching time period of the first switch overlapping in time with the second switching time period of the second switch. The communications manager 620 may be configured as or otherwise support a means for transmitting a message after at least a portion of the switching, where transmission of the message is in accordance with a scheduling rule that defines whether transmission is allowed during a conditional transmission time that is after completion of the first switching time period and before completion of the second switching time period.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing, reduced power consumption, and more efficient utilization of communication resources.

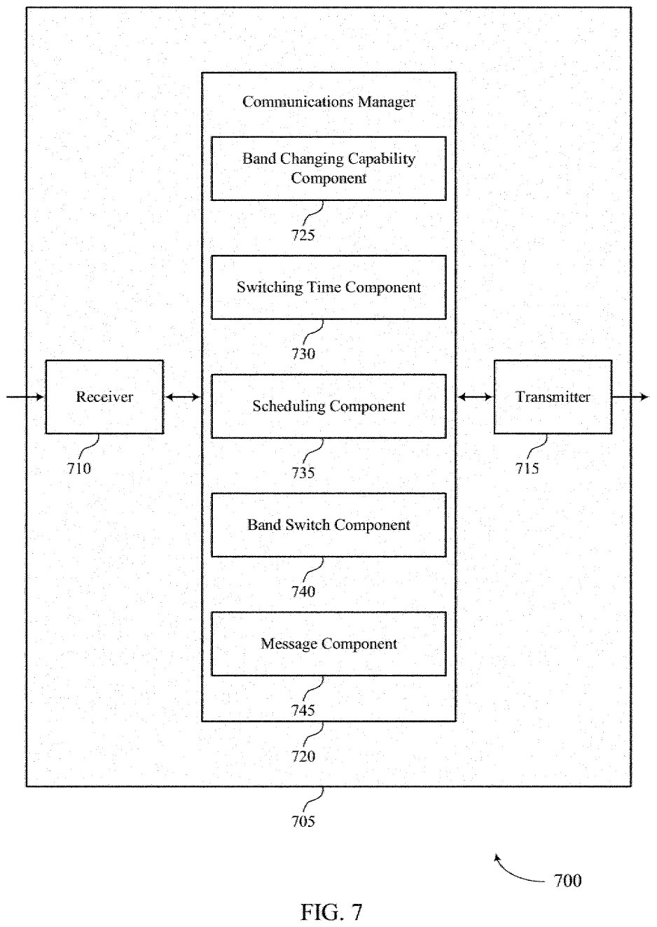

FIG. 7 illustrates a block diagram 700 of a device 705 that supports scheduling for frequency bands associated with a first band changing capability after a transmit chain switch in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to scheduling for frequency bands associated with a first band changing capability after a transmit chain switch). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to scheduling for frequency bands associated with a first band changing capability after a transmit chain switch). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of scheduling for frequency bands associated with a first band changing capability after a transmit chain switch as described herein. For example, the communications manager 720 may include a band changing capability component 725, a switching time component 730, a scheduling component 735, a band switch component 740, a message component 745, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The band changing capability component 725 may be configured as or otherwise support a means for transmitting first capability information that indicates a first frequency band is associated with a first band changing capability, where the first band changing capability indicates the UE will maintain a mapping between a first transmit chain of the UE and the first frequency band while performing other scheduled frequency band switches using a second transmit chain of the UE. The switching time component 730 may be configured as or otherwise support a means for transmitting second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period. The scheduling component 735 may be configured as or otherwise support a means for receiving scheduling information that schedules a change between communications by the UE on a band pair, that includes the first frequency band and the third frequency band, and communications by the UE on the second frequency band. The band switch component 740 may be configured as or otherwise support a means for switching between the band pair and the second frequency band based on the scheduling information, where the switching includes the first switch and the second switch, the first switching time period of the first switch overlapping in time with the second switching time period of the second switch. The message component 745 may be configured as or otherwise support a means for transmitting a message after at least a portion of the switching, where transmission of the message is in accordance with a scheduling rule that defines whether transmission is allowed during a conditional transmission time that is after completion of the first switching time period and before completion of the second switching time period.

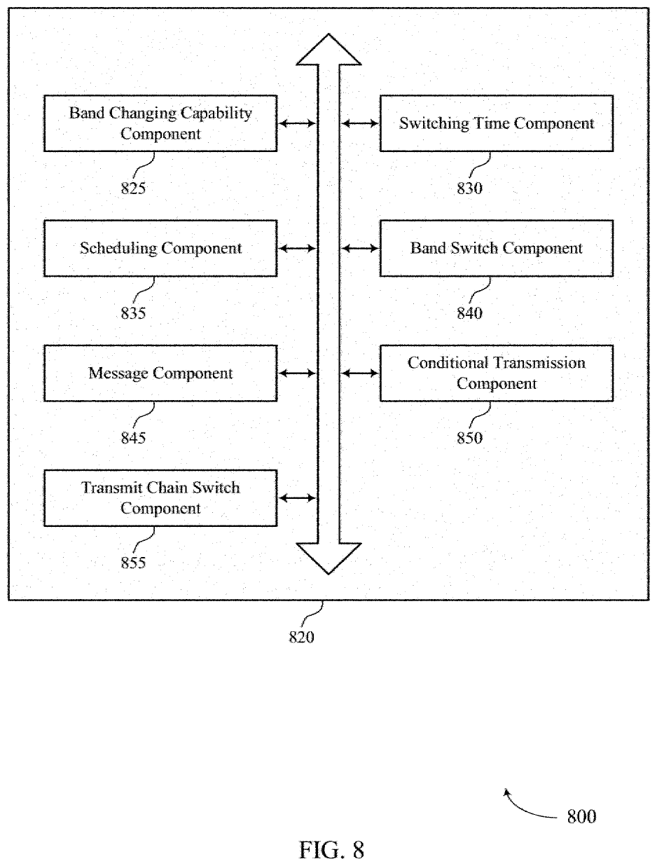

FIG. 8 illustrates a block diagram 800 of a communications manager 820 that supports scheduling for frequency bands associated with a first band changing capability after a transmit chain switch in accordance with one or more aspects of the present disclosure. The communications manager 820 may be an example of aspects of a communications manager 620, a communications manager 720, or both, as described herein. The communications manager 820, or various components thereof, may be an example of means for performing various aspects of scheduling for frequency bands associated with a first band changing capability after a transmit chain switch as described herein. For example, the communications manager 820 may include a band changing capability component 825, a switching time component 830, a scheduling component 835, a band switch component 840, a message component 845, a conditional transmission component 850, a transmit chain switch component 855, or any combination thereof. Each of these components may communicate, directly or indirectly, with one another (e.g., via one or more buses).

Additionally, or alternatively, the communications manager 820 may support wireless communication at a UE in accordance with examples as disclosed herein. The band changing capability component 825 may be configured as or otherwise support a means for transmitting first capability information that indicates a first frequency band is associated with a first band changing capability, where the first band changing capability indicates the UE will maintain a mapping between a first transmit chain of the UE and the first frequency band while performing other scheduled frequency band switches using a second transmit chain of the UE. The switching time component 830 may be configured as or otherwise support a means for transmitting second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period. The scheduling component 835 may be configured as or otherwise support a means for receiving scheduling information that schedules a change between communications by the UE on a band pair, that includes the first frequency band and the third frequency band, and communications by the UE on the second frequency band. The band switch component 840 may be configured as or otherwise support a means for switching between the band pair and the second frequency band based on the scheduling information, where the switching includes the first switch and the second switch, the first switching time period of the first switch overlapping in time with the second switching time period of the second switch. The message component 845 may be configured as or otherwise support a means for transmitting a message after at least a portion of the switching, where transmission of the message is in accordance with a scheduling rule that defines whether transmission is allowed during a conditional transmission time that is after completion of the first switching time period and before completion of the second switching time period.

In some examples, the second frequency band is associated with the first band changing capability, and, to support transmitting the message, the conditional transmission component 850 may be configured as or otherwise support a means for transmitting the message during the conditional transmission time that is after the completion of the first switching time period and before the completion of the second switching time period based on the scheduling rule, where the scheduling rule defines that transmission is allowed during the conditional transmission time when the first switch is between two frequency bands associated with the first band changing capability.

In some examples, to support transmitting the first capability information, the band changing capability component 825 may be configured as or otherwise support a means for transmitting, via the first capability information, an indication that the second frequency band is associated with the first band changing capability.

In some examples, to support switching between the band pair and the second frequency band, the band switch component 840 may be configured as or otherwise support a means for switching from the band pair to the second frequency band, where the message is transmitted on the second frequency band using the first transmit chain of the UE during the conditional transmission time.

In some examples, to support switching between the band pair and the second frequency band, the band switch component 840 may be configured as or otherwise support a means for switching from the second frequency band to the band pair, where the message is transmitted on the first frequency band of the band pair using the first transmit chain of the UE during the conditional transmission time.

In some examples, to support receiving the scheduling information, the scheduling component 835 may be configured as or otherwise support a means for receiving, via the scheduling information, an indication of resources allocated for the transmission of the message during the conditional transmission time based on the scheduling rule.

In some examples, the message component 845 may be configured as or otherwise support a means for transmitting a second message after the completion of the second switching time period, where the second message is transmitted using the first transmit chain of the UE, the second transmit chain of the UE, or both.

In some examples, to support transmitting the message, the message component 845 may be configured as or otherwise support a means for transmitting the message after the completion of the second switching time period based on the scheduling rule, where the scheduling rule defines that transmission is not allowed during the conditional transmission time when a single frequency band of a set of frequency bands is associated with the first band changing capability, the set of frequency bands including the first frequency band, the second frequency band, and the third frequency band.

In some examples, to support receiving the scheduling information, the scheduling component 835 may be configured as or otherwise support a means for receiving, via the scheduling information, an indication of resources allocated for the transmission of the message after the completion of the second switching time period based on the scheduling rule.

In some examples, to support switching between the band pair and the second frequency band, the transmit chain switch component 855 may be configured as or otherwise support a means for switching the first transmit chain of the UE between the first frequency band and the second frequency band during the first switching time period. In some examples, to support switching between the band pair and the second frequency band, the transmit chain switch component 855 may be configured as or otherwise support a means for switching the second transmit chain of the UE between the third frequency band and the second frequency band during the second switching time period.

In some examples, to support switching between the band pair and the second frequency band, the band switch component 840 may be configured as or otherwise support a means for switching from the band pair to the second frequency band in accordance with the scheduling information, where the scheduling information schedules the transmission of the message on the second frequency band.

In some examples, to support switching between the band pair and the second frequency band, the band switch component 840 may be configured as or otherwise support a means for switching from the second frequency band to the band pair in accordance with the scheduling information, where the scheduling information schedules the transmission of the message on the first frequency band of the band pair, the third frequency band of the band pair, or both.

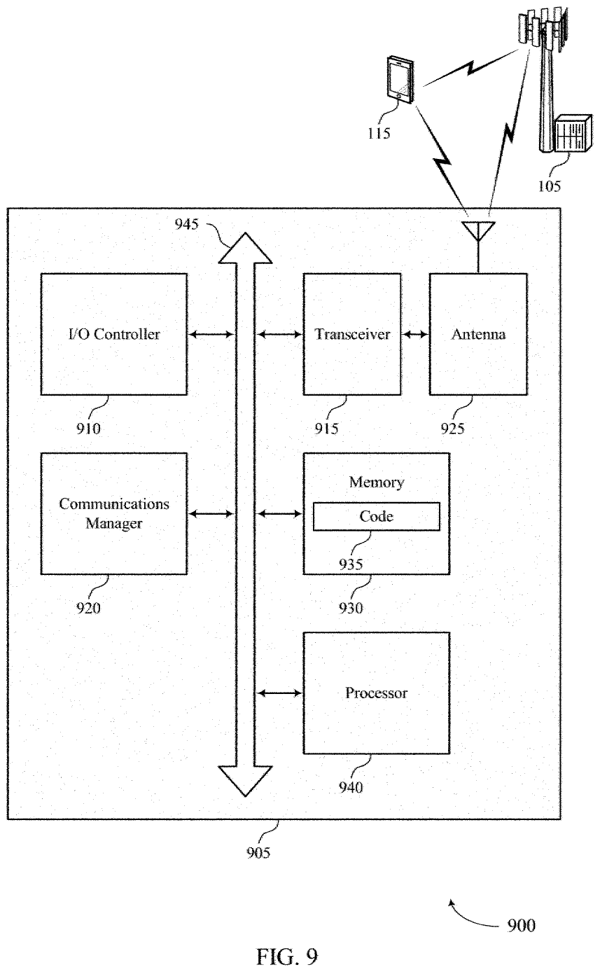

FIG. 9 illustrates a diagram of a system 900 including a device 905 that supports scheduling for frequency bands associated with a first band changing capability after a transmit chain switch in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting scheduling for frequency bands associated with a first band changing capability after a transmit chain switch). For example, the device 905 or a component of the device 905 may include a processor 940 and memory 930 coupled with or to the processor 940, the processor 940 and memory 930 configured to perform various functions described herein.

Additionally, or alternatively, the communications manager 920 may support wireless communication at a UE in accordance with examples as disclosed herein. For example, the communications manager 920 may be configured as or otherwise support a means for transmitting first capability information that indicates a first frequency band is associated with a first band changing capability, where the first band changing capability indicates the UE will maintain a mapping between a first transmit chain of the UE and the first frequency band while performing other scheduled frequency band switches using a second transmit chain of the UE. The communications manager 920 may be configured as or otherwise support a means for transmitting second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period. The communications manager 920 may be configured as or otherwise support a means for receiving scheduling information that schedules a change between communications by the UE on a band pair, that includes the first frequency band and the third frequency band, and communications by the UE on the second frequency band. The communications manager 920 may be configured as or otherwise support a means for switching between the band pair and the second frequency band based on the scheduling information, where the switching includes the first switch and the second switch, the first switching time period of the first switch overlapping in time with the second switching time period of the second switch. The communications manager 920 may be configured as or otherwise support a means for transmitting a message after at least a portion of the switching, where transmission of the message is in accordance with a scheduling rule that defines whether transmission is allowed during a conditional transmission time that is after completion of the first switching time period and before completion of the second switching time period.

By including or configuring the communications manager 920 in accordance with examples as described herein, the device 905 may support techniques for improved communication reliability, reduced latency, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of scheduling for frequency bands associated with a first band changing capability after a transmit chain switch as described herein, or the processor 940 and the memory 930 may be otherwise configured to perform or support such operations.

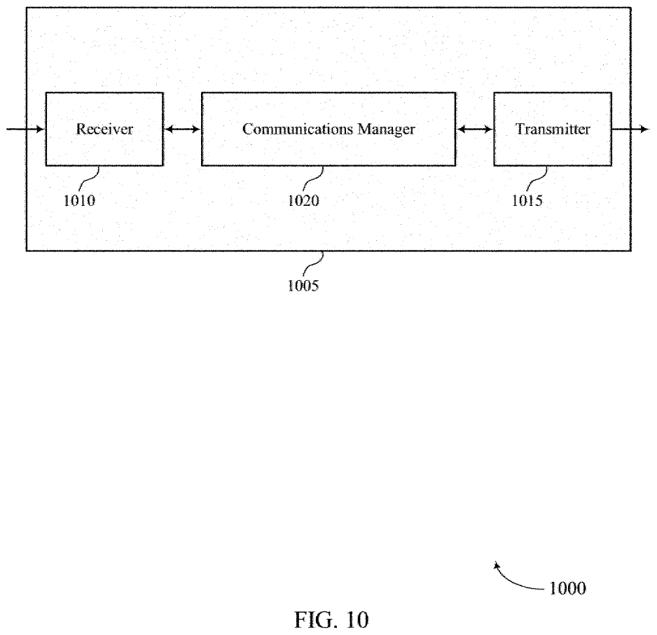

FIG. 10 illustrates a block diagram 1000 of a device 1005 that supports scheduling for frequency bands associated with a first band changing capability after a transmit chain switch in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of scheduling for frequency bands associated with a first band changing capability after a transmit chain switch as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

Additionally, or alternatively, the communications manager 1020 may support wireless communication at a network entity in accordance with examples as disclosed herein. For example, the communications manager 1020 may be configured as or otherwise support a means for receiving first capability information that indicates a first frequency band is associated with a first band changing capability, where the first band changing capability indicates a UE will maintain a mapping between a first transmit chain of the UE and the first frequency band while performing other scheduled frequency band switches using a second transmit chain of the UE. The communications manager 1020 may be configured as or otherwise support a means for receiving second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period. The communications manager 1020 may be configured as or otherwise support a means for transmitting scheduling information that schedules a change between communications by the UE on a band pair, that includes the first frequency band and the third frequency band, and communications by the UE on the second frequency band, where a switch between the band pair and the second frequency band includes the first switch and the second switch, the first switching time period of the first switch overlapping in time with the second switching time period of the second switch. The communications manager 1020 may be configured as or otherwise support a means for receiving a message after at least a portion of the switching, where reception of the message is in accordance with a scheduling rule that defines whether transmission by the UE is allowed during a conditional transmission time that is after completion of the first switching time period and before completion of the second switching time period.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing, reduced power consumption, and more efficient utilization of communication resources.

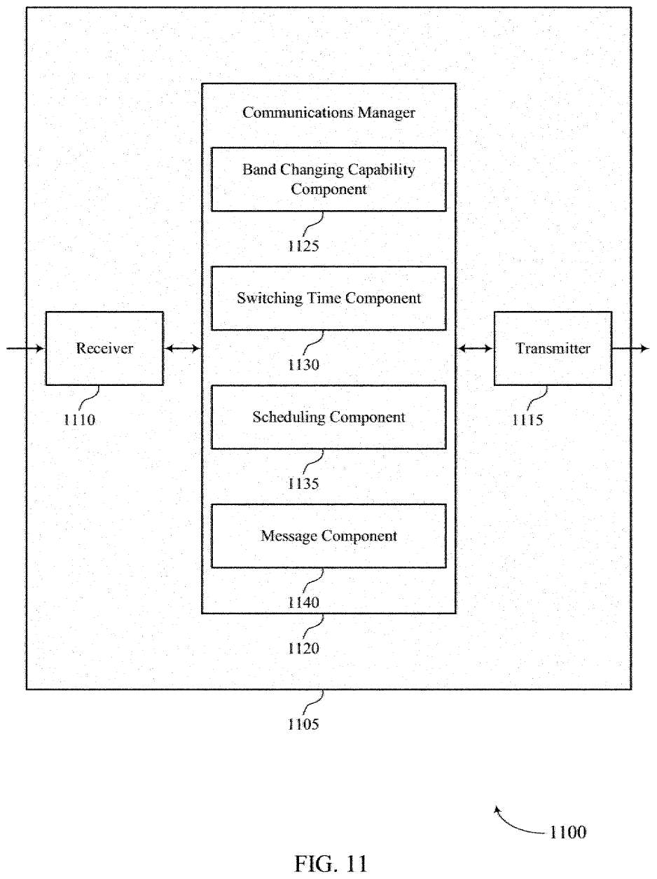

FIG. 11 illustrates a block diagram 1100 of a device 1105 that supports scheduling for frequency bands associated with a first band changing capability after a transmit chain switch in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas.

Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of scheduling for frequency bands associated with a first band changing capability after a transmit chain switch as described herein. For example, the communications manager 1120 may include a band changing capability component 1125, a switching time component 1130, a scheduling component 1135, a message component 1140, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The band changing capability component 1125 may be configured as or otherwise support a means for receiving first capability information that indicates a first frequency band is associated with a first band changing capability, where the first band changing capability indicates a UE will maintain a mapping between a first transmit chain of the UE and the first frequency band while performing other scheduled frequency band switches using a second transmit chain of the UE. The switching time component 1130 may be configured as or otherwise support a means for receiving second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period. The scheduling component 1135 may be configured as or otherwise support a means for transmitting scheduling information that schedules a change between communications by the UE on a band pair, that includes the first frequency band and the third frequency band, and communications by the UE on the second frequency band, where a switch between the band pair and the second frequency band includes the first switch and the second switch, the first switching time period of the first switch overlapping in time with the second switching time period of the second switch. The message component 1140 may be configured as or otherwise support a means for receiving a message after at least a portion of the switching, where reception of the message is in accordance with a scheduling rule that defines whether transmission by the UE is allowed during a conditional transmission time that is after completion of the first switching time period and before completion of the second switching time period.

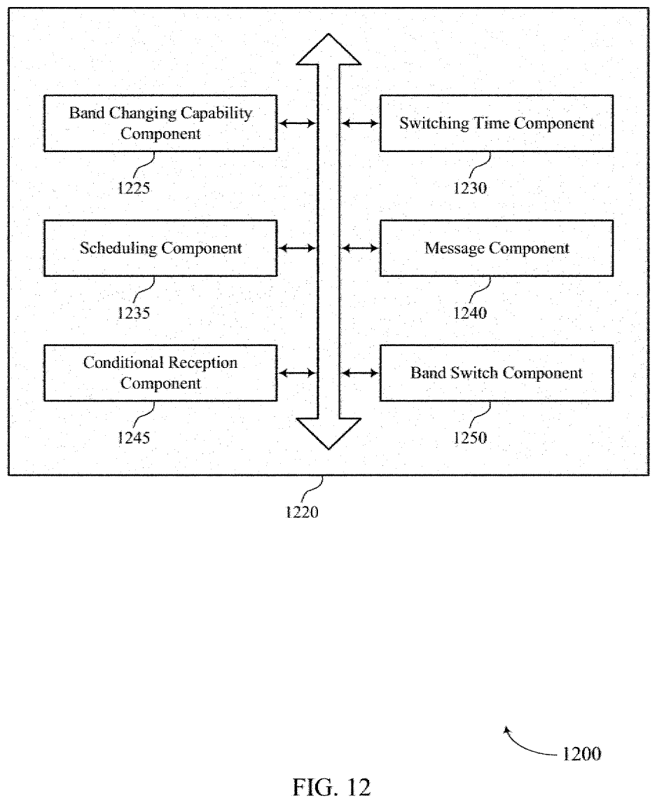

FIG. 12 illustrates a block diagram 1200 of a communications manager 1220 that supports scheduling for frequency bands associated with a first band changing capability after a transmit chain switch in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of scheduling for frequency bands associated with a first band changing capability after a transmit chain switch as described herein. For example, the communications manager 1220 may include a band changing capability component 1225, a switching time component 1230, a scheduling component 1235, a message component 1240, a conditional reception component 1245, a band switch component 1250, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 1220 may support wireless communication at a network entity in accordance with examples as disclosed herein. The band changing capability component 1225 may be configured as or otherwise support a means for receiving first capability information that indicates a first frequency band is associated with a first band changing capability, where the first band changing capability indicates a UE will maintain a mapping between a first transmit chain of the UE and the first frequency band while performing other scheduled frequency band switches using a second transmit chain of the UE. The switching time component 1230 may be configured as or otherwise support a means for receiving second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period. The scheduling component 1235 may be configured as or otherwise support a means for transmitting scheduling information that schedules a change between communications by the UE on a band pair, that includes the first frequency band and the third frequency band, and communications by the UE on the second frequency band, where a switch between the band pair and the second frequency band includes the first switch and the second switch, the first switching time period of the first switch overlapping in time with the second switching time period of the second switch. The message component 1240 may be configured as or otherwise support a means for receiving a message after at least a portion of the switching, where reception of the message is in accordance with a scheduling rule that defines whether transmission by the UE is allowed during a conditional transmission time that is after completion of the first switching time period and before completion of the second switching time period.

In some examples, the second frequency band is associated with the first band changing capability, and, to support receiving the message, the conditional reception component 1245 may be configured as or otherwise support a means for receiving the message during the conditional transmission time that is after the completion of the first switching time period and before the completion of the second switching time period based on the scheduling rule, where the scheduling rule defines that transmission by the UE is allowed during the conditional transmission time when the first switch is between two frequency bands associated with the first band changing capability.

In some examples, to support receiving the first capability information, the band changing capability component 1225 may be configured as or otherwise support a means for receiving, via the first capability information, an indication that the second frequency band is associated with the first band changing capability.

In some examples, the switch is from the band pair to the second frequency band, and the message is received on the second frequency band during the conditional transmission time. In some examples, the switch is from the second frequency band to the band pair, and the message is received on the first frequency band of the band pair during the conditional transmission time.

In some examples, to support transmitting the scheduling information, the scheduling component 1235 may be configured as or otherwise support a means for transmitting, via the scheduling information, an indication of resources allocated for the message during the conditional transmission time based on the scheduling rule.

In some examples, to support receiving the message, the message component 1240 may be configured as or otherwise support a means for receiving the message after the completion of the second switching time period based on the scheduling rule, where the scheduling rule defines that transmission by the UE is not allowed during the conditional transmission time when a single frequency band of a set of frequency bands is associated with the first band changing capability, the set of frequency bands including the first frequency band, the second frequency band, and the third frequency band.

In some examples, to support transmitting the scheduling information, the scheduling component 1235 may be configured as or otherwise support a means for transmitting, via the scheduling information, an indication of resources allocated for the message after the completion of the second switching time period based on the scheduling rule.

In some examples, to support transmitting the scheduling information, the band switch component 1250 may be configured as or otherwise support a means for transmitting, via the scheduling information, information that schedules a change from the band pair to the second frequency band, where the scheduling information schedules the message on the second frequency band.

In some examples, to support transmitting the scheduling information, the band switch component 1250 may be configured as or otherwise support a means for transmitting, via the scheduling information, information that schedules a change from the second frequency band to the band pair, where the scheduling information schedules the message on the first frequency band of the band pair, the third frequency band of the band pair, or both.

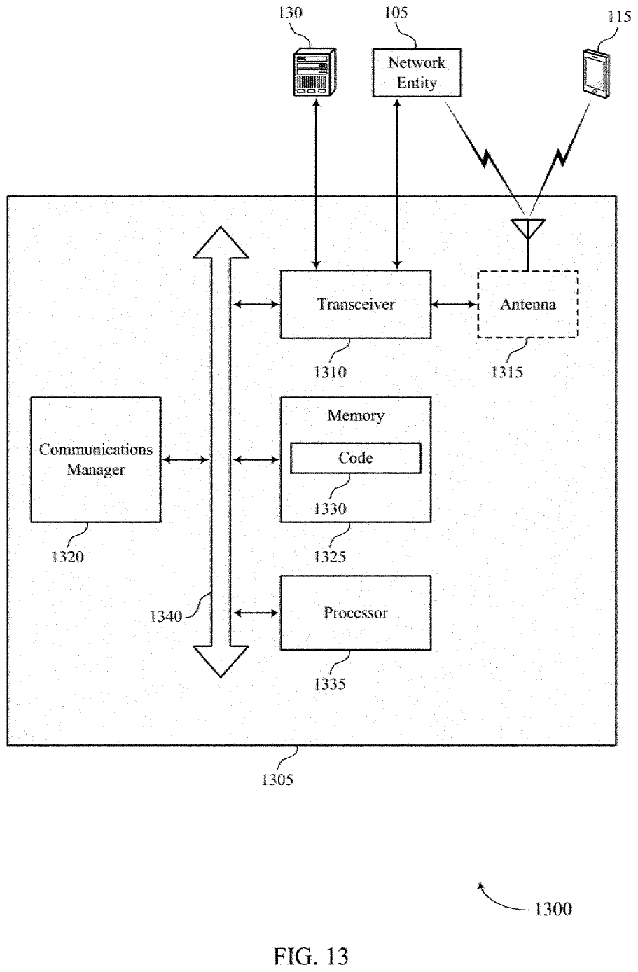

FIG. 13 illustrates a diagram of a system 1300 including a device 1305 that supports scheduling for frequency bands associated with a first band changing capability after a transmit chain switch in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting scheduling for frequency bands associated with a first band changing capability after a transmit chain switch). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

Additionally, or alternatively, the communications manager 1320 may support wireless communication at a network entity in accordance with examples as disclosed herein. For example, the communications manager 1320 may be configured as or otherwise support a means for receiving first capability information that indicates a first frequency band is associated with a first band changing capability, where the first band changing capability indicates a UE will maintain a mapping between a first transmit chain of the UE and the first frequency band while performing other scheduled frequency band switches using a second transmit chain of the UE. The communications manager 1320 may be configured as or otherwise support a means for receiving second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period. The communications manager 1320 may be configured as or otherwise support a means for transmitting scheduling information that schedules a change between communications by the UE on a band pair, that includes the first frequency band and the third frequency band, and communications by the UE on the second frequency band, where a switch between the band pair and the second frequency band includes the first switch and the second switch, the first switching time period of the first switch overlapping in time with the second switching time period of the second switch. The communications manager 1320 may be configured as or otherwise support a means for receiving a message after at least a portion of the switching, where reception of the message is in accordance with a scheduling rule that defines whether transmission by the UE is allowed during a conditional transmission time that is after completion of the first switching time period and before completion of the second switching time period.

By including or configuring the communications manager 1320 in accordance with examples as described herein, the device 1305 may support techniques for improved communication reliability, reduced latency, reduced power consumption, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of scheduling for frequency bands associated with a first band changing capability after a transmit chain switch as described herein, or the processor 1335 and the memory 1325 may be otherwise configured to perform or support such operations.

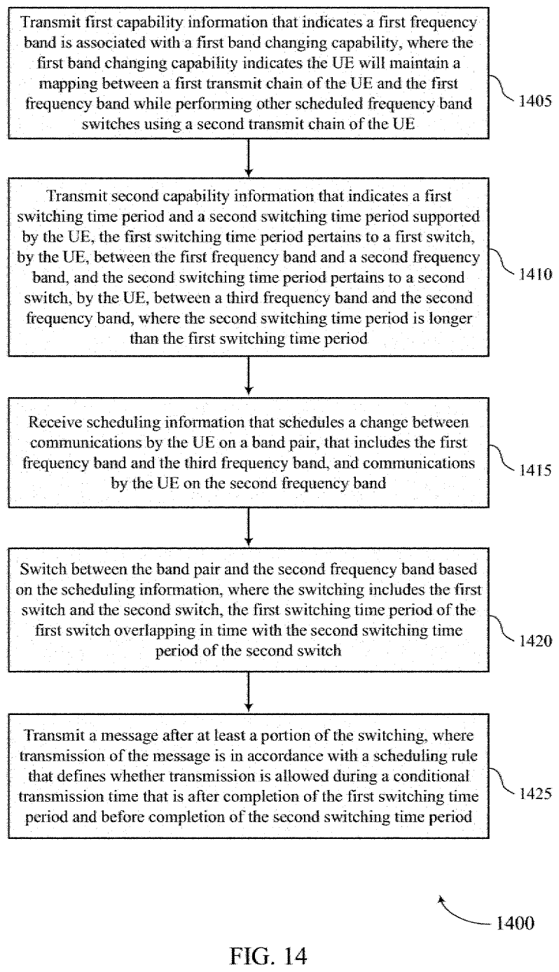

FIG. 14 illustrates a flowchart showing a method 1400 that supports scheduling for frequency bands associated with a first band changing capability after a transmit chain switch in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include transmitting first capability information that indicates a first frequency band is associated with a first band changing capability, where the first band changing capability indicates the UE will maintain a mapping between a first transmit chain of the UE and the first frequency band while performing other scheduled frequency band switches using a second transmit chain of the UE. The operations of 1405 may be performed in accordance with examples as disclosed herein. In some examples, aspects of the operations of 1405 may be performed by a band changing capability component 825 as described with reference to FIG. 8.

At 1410, the method may include transmitting second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period. The operations of 1410 may be performed in accordance with examples as disclosed herein. In some examples, aspects of the operations of 1410 may be performed by a switching time component 830 as described with reference to FIG. 8.

At 1415, the method may include receiving scheduling information that schedules a change between communications by the UE on a band pair, that includes the first frequency band and the third frequency band, and communications by the UE on the second frequency band. The operations of 1415 may be performed in accordance with examples as disclosed herein. In some examples, aspects of the operations of 1415 may be performed by a scheduling component 835 as described with reference to FIG. 8.

At 1420, the method may include switching between the band pair and the second frequency band based on the scheduling information, where the switching includes the first switch and the second switch, the first switching time period of the first switch overlapping in time with the second switching time period of the second switch. The operations of 1420 may be performed in accordance with examples as disclosed herein. In some examples, aspects of the operations of 1420 may be performed by a band switch component 840 as described with reference to FIG. 8.

At 1425, the method may include transmitting a message after at least a portion of the switching, where transmission of the message is in accordance with a scheduling rule that defines whether transmission is allowed during a conditional transmission time that is after completion of the first switching time period and before completion of the second switching time period. The operations of 1425 may be performed in accordance with examples as disclosed herein. In some examples, aspects of the operations of 1425 may be performed by a message component 845 as described with reference to FIG. 8.

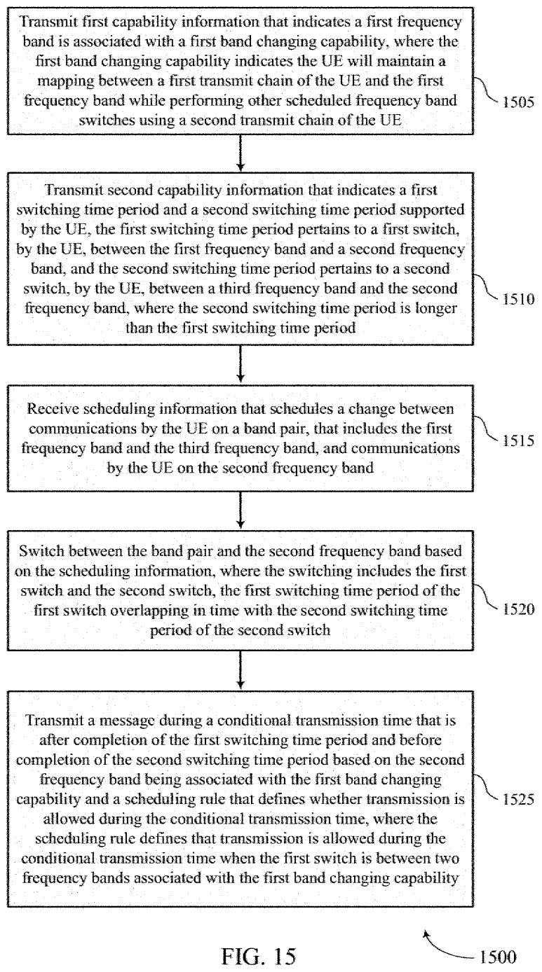

FIG. 15 illustrates a flowchart showing a method 1500 that supports scheduling for frequency bands associated with a first band changing capability after a transmit chain switch in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include transmitting first capability information that indicates a first frequency band is associated with a first band changing capability, where the first band changing capability indicates the UE will maintain a mapping between a first transmit chain of the UE and the first frequency band while performing other scheduled frequency band switches using a second transmit chain of the UE. The operations of 1505 may be performed in accordance with examples as disclosed herein. In some examples, aspects of the operations of 1505 may be performed by a band changing capability component 825 as described with reference to FIG. 8.

At 1510, the method may include transmitting second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period. The operations of 1510 may be performed in accordance with examples as disclosed herein. In some examples, aspects of the operations of 1510 may be performed by a switching time component 830 as described with reference to FIG. 8.

At 1515, the method may include receiving scheduling information that schedules a change between communications by the UE on a band pair, that includes the first frequency band and the third frequency band, and communications by the UE on the second frequency band. The operations of 1515 may be performed in accordance with examples as disclosed herein. In some examples, aspects of the operations of 1515 may be performed by a scheduling component 835 as described with reference to FIG. 8.

At 1520, the method may include switching between the band pair and the second frequency band based on the scheduling information, where the switching includes the first switch and the second switch, the first switching time period of the first switch overlapping in time with the second switching time period of the second switch. The operations of 1520 may be performed in accordance with examples as disclosed herein. In some examples, aspects of the operations of 1520 may be performed by a band switch component 840 as described with reference to FIG. 8.

At 1525, the method may include transmitting a message during a conditional transmission time that is after completion of the first switching time period and before completion of the second switching time period based on the second frequency band being associated with the first band changing capability and a scheduling rule that defines whether transmission is allowed during the conditional transmission time, where the scheduling rule defines that transmission is allowed during the conditional transmission time when the first switch is between two frequency bands associated with the first band changing capability. The operations of 1525 may be performed in accordance with examples as disclosed herein. In some examples, aspects of the operations of 1525 may be performed by a conditional transmission component 850 as described with reference to FIG. 8.

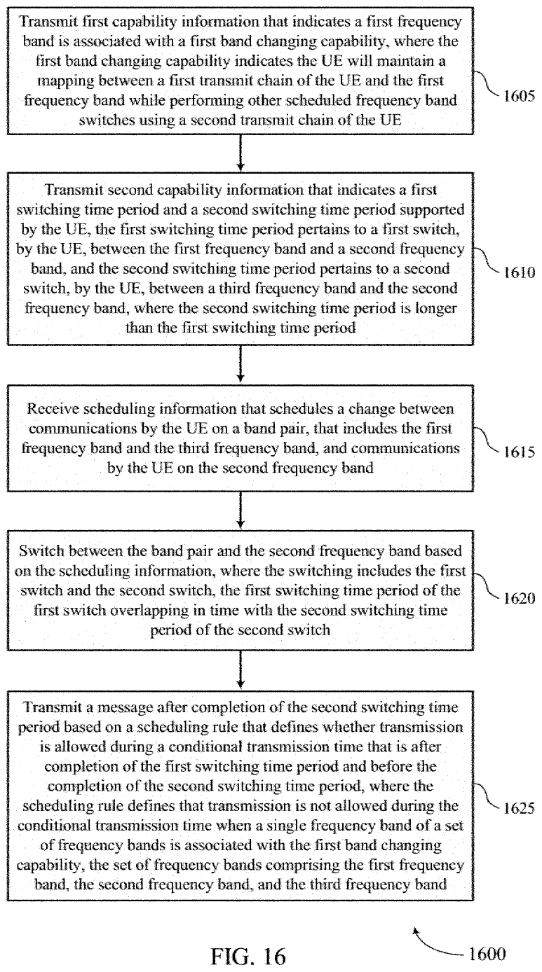

FIG. 16 illustrates a flowchart showing a method 1600 that supports scheduling for frequency bands associated with a first band changing capability after a transmit chain switch in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include transmitting first capability information that indicates a first frequency band is associated with a first band changing capability, where the first band changing capability indicates the UE will maintain a mapping between a first transmit chain of the UE and the first frequency band while performing other scheduled frequency band switches using a second transmit chain of the UE. The operations of 1605 may be performed in accordance with examples as disclosed herein. In some examples, aspects of the operations of 1605 may be performed by a band changing capability component 825 as described with reference to FIG. 8.

At 1610, the method may include transmitting second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period. The operations of 1610 may be performed in accordance with examples as disclosed herein. In some examples, aspects of the operations of 1610 may be performed by a switching time component 830 as described with reference to FIG. 8.

At 1615, the method may include receiving scheduling information that schedules a change between communications by the UE on a band pair, that includes the first frequency band and the third frequency band, and communications by the UE on the second frequency band. The operations of 1615 may be performed in accordance with examples as disclosed herein. In some examples, aspects of the operations of 1615 may be performed by a scheduling component 835 as described with reference to FIG. 8.

At 1620, the method may include switching between the band pair and the second frequency band based on the scheduling information, where the switching includes the first switch and the second switch, the first switching time period of the first switch overlapping in time with the second switching time period of the second switch. The operations of 1620 may be performed in accordance with examples as disclosed herein. In some examples, aspects of the operations of 1620 may be performed by a band switch component 840 as described with reference to FIG. 8.

At 1625, the method may include transmitting a message after completion of the second switching time based on a scheduling rule that defines whether transmission is allowed during a conditional transmission time that is after completion of the first switching time period and before the completion of the second switching time period, where the scheduling rule defines that transmission is not allowed during the conditional transmission time when a single frequency band of a set of frequency bands is associated with the first band changing capability, the set of frequency bands including the first frequency band, the second frequency band, and the third frequency band. The operations of 1625 may be performed in accordance with examples as disclosed herein. In some examples, aspects of the operations of 1625 may be performed by a message component 845 as described with reference to FIG. 8.

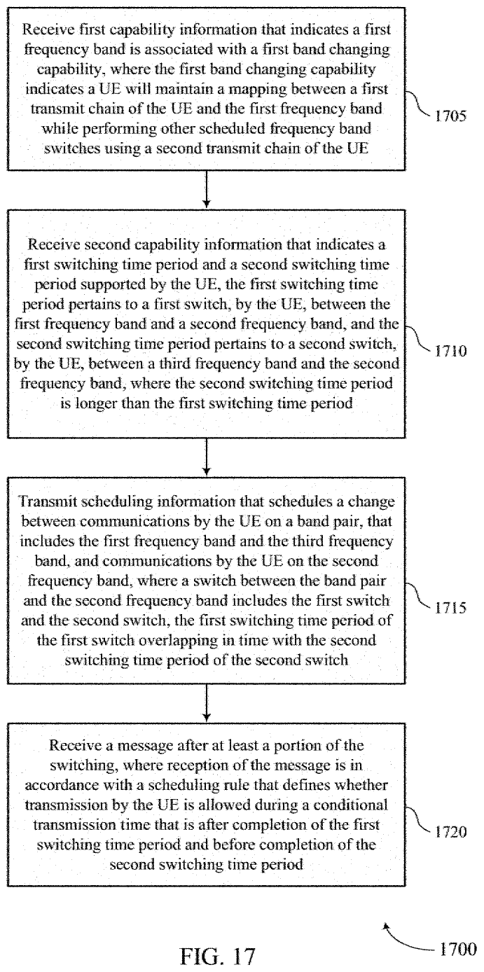

FIG. 17 illustrates a flowchart showing a method 1700 that supports scheduling for frequency bands associated with a first band changing capability after a transmit chain switch in accordance with one or more aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1705, the method may include receiving first capability information that indicates a first frequency band is associated with a first band changing capability, where the first band changing capability indicates a UE will maintain a mapping between a first transmit chain of the UE and the first frequency band while performing other scheduled frequency band switches using a second transmit chain of the UE. The operations of 1705 may be performed in accordance with examples as disclosed herein. In some examples, aspects of the operations of 1705 may be performed by a band changing capability component 1225 as described with reference to FIG. 12.

At 1710, the method may include receiving second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period. The operations of 1710 may be performed in accordance with examples as disclosed herein. In some examples, aspects of the operations of 1710 may be performed by a switching time component 1230 as described with reference to FIG. 12.

At 1715, the method may include transmitting scheduling information that schedules a change between communications by the UE on a band pair, that includes the first frequency band and the third frequency band, and communications by the UE on the second frequency band, where a switch between the band pair and the second frequency band includes the first switch and the second switch, the first switching time period of the first switch overlapping in time with the second switching time period of the second switch. The operations of 1715 may be performed in accordance with examples as disclosed herein. In some examples, aspects of the operations of 1715 may be performed by a scheduling component 1235 as described with reference to FIG. 12.

At 1720, the method may include receiving a message after at least a portion of the switching, where reception of the message is in accordance with a scheduling rule that defines whether transmission by the UE is allowed during a conditional transmission time that is after completion of the first switching time period and before completion of the second switching time period. The operations of 1720 may be performed in accordance with examples as disclosed herein. In some examples, aspects of the operations of 1720 may be performed by a message component 1240 as described with reference to FIG. 12.

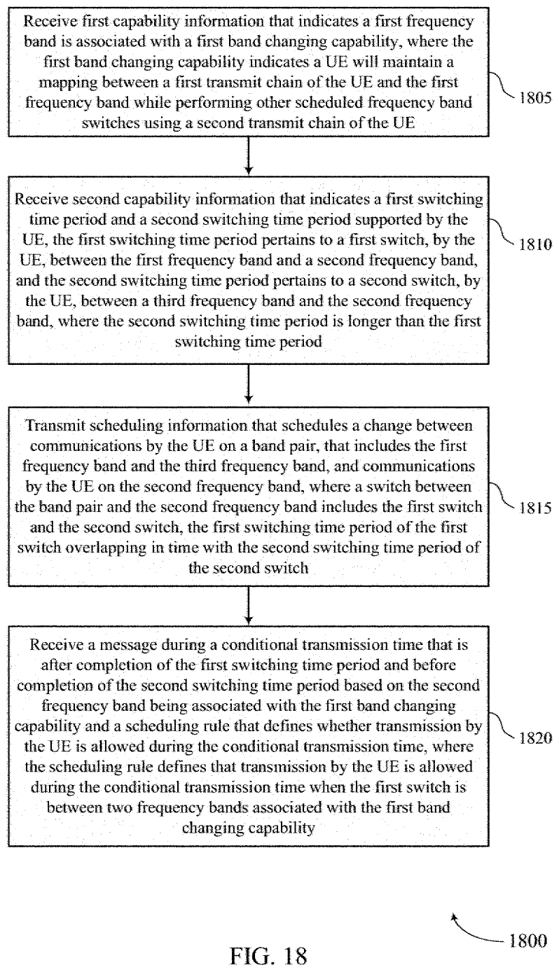

FIG. 18 illustrates a flowchart showing a method 1800 that supports scheduling for frequency bands associated with a first band changing capability after a transmit chain switch in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include receiving first capability information that indicates a first frequency band is associated with a first band changing capability, where the first band changing capability indicates a UE will maintain a mapping between a first transmit chain of the UE and the first frequency band while performing other scheduled frequency band switches using a second transmit chain of the UE. The operations of 1805 may be performed in accordance with examples as disclosed herein. In some examples, aspects of the operations of 1805 may be performed by a band changing capability component 1225 as described with reference to FIG. 12.

At 1810, the method may include receiving second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, where the second switching time period is longer than the first switching time period. The operations of 1810 may be performed in accordance with examples as disclosed herein. In some examples, aspects of the operations of 1810 may be performed by a switching time component 1230 as described with reference to FIG. 12.

At 1815, the method may include transmitting scheduling information that schedules a change between communications by the UE on a band pair, that includes the first frequency band and the third frequency band, and communications by the UE on the second frequency band, where a switch between the band pair and the second frequency band includes the first switch and the second switch, the first switching time period of the first switch overlapping in time with the second switching time period of the second switch. The operations of 1815 may be performed in accordance with examples as disclosed herein. In some examples, aspects of the operations of 1815 may be performed by a scheduling component 1235 as described with reference to FIG. 12.

At 1820, the method may include receiving a message during a conditional transmission time that is after completion of the first switching time period and before completion of the second switching time period based on the second frequency band being associated with the first band changing capability and a scheduling rule that defines whether transmission is allowed during the conditional transmission time, where the scheduling rule defines that transmission by the UE is allowed during the conditional transmission time when the first switch is between two frequency bands associated with the first band changing capability. The operations of 1820 may be performed in accordance with examples as disclosed herein. In some examples, aspects of the operations of 1820 may be performed by a conditional reception component 1245 as described with reference to FIG. 12.

The following provides an overview of aspects of the present disclosure:

Aspect 1: A method for wireless communication at a UE, comprising: transmitting first capability information that indicates a first frequency band is associated with a first band changing capability, wherein the first band changing capability indicates the UE will maintain a mapping between a first transmit chain of the UE and the first frequency band while performing other scheduled frequency band switches using a second transmit chain of the UE; transmitting second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, wherein the second switching time period is longer than the first switching time period; receiving scheduling information that schedules a change between communications by the UE on a band pair, that includes the first frequency band and the third frequency band, and communications by the UE on the second frequency band; switching between the band pair and the second frequency band based at least in part on the scheduling information, wherein the switching comprises the first switch and the second switch, the first switching time period of the first switch overlapping in time with the second switching time period of the second switch; and transmitting a message after at least a portion of the switching, wherein transmission of the message is in accordance with a scheduling rule that defines whether transmission is allowed during a conditional transmission time that is after completion of the first switching time period and before completion of the second switching time period.

Aspect 2: The method of aspect 1, wherein the second frequency band is associated with the first band changing capability, and wherein transmitting the message comprises: transmitting the message during the conditional transmission time that is after the completion of the first switching time period and before the completion of the second switching time period based at least in part on the scheduling rule, wherein the scheduling rule defines that transmission is allowed during the conditional transmission time when the first switch is between two frequency bands associated with the first band changing capability.

Aspect 3: The method of aspect 2, wherein transmitting the first capability information comprises: transmitting, via the first capability information, an indication that the second frequency band is associated with the first band changing capability.

Aspect 4: The method of any of aspects 2 through 3, wherein switching between the band pair and the second frequency band comprises: switching from the band pair to the second frequency band, wherein the message is transmitted on the second frequency band using the first transmit chain of the UE during the conditional transmission time.

Aspect 5: The method of any of aspects 2 through 3, wherein switching between the band pair and the second frequency band comprises: switching from the second frequency band to the band pair, wherein the message is transmitted on the first frequency band of the band pair using the first transmit chain of the UE during the conditional transmission time.

Aspect 6: The method of any of aspects 2 through 5, wherein receiving the scheduling information comprises: receiving, via the scheduling information, an indication of resources allocated for the transmission of the message during the conditional transmission time based at least in part on the scheduling rule.

Aspect 7: The method of any of aspects 2 through 6, further comprising: transmitting a second message after the completion of the second switching time period, wherein the second message is transmitted using the first transmit chain of the UE, the second transmit chain of the UE, or both.

Aspect 8: The method of aspect 1, wherein transmitting the message comprises: transmitting the message after the completion of the second switching time period based at least in part on the scheduling rule, wherein the scheduling rule defines that transmission is not allowed during the conditional transmission time when a single frequency band of a set of frequency bands is associated with the first band changing capability, the set of frequency bands comprising the first frequency band, the second frequency band, and the third frequency band.

Aspect 9: The method of aspect 8, wherein receiving the scheduling information comprises: receiving, via the scheduling information, an indication of resources allocated for the transmission of the message after the completion of the second switching time period based at least in part on the scheduling rule.

Aspect 10: The method of any of aspects 1 through 9, wherein switching between the band pair and the second frequency band comprises: switching the first transmit chain of the UE between the first frequency band and the second frequency band during the first switching time period; and switching the second transmit chain of the UE between the third frequency band and the second frequency band during the second switching time period.

Aspect 11: The method of any of aspects 1 through 10, wherein switching between the band pair and the second frequency band comprises: switching from the band pair to the second frequency band in accordance with the scheduling information, wherein the scheduling information schedules the transmission of the message on the second frequency band.

Aspect 12: The method of any of aspects 1 through 10, wherein switching between the band pair and the second frequency band comprises: switching from the second frequency band to the band pair in accordance with the scheduling information, wherein the scheduling information schedules the transmission of the message on the first frequency band of the band pair, the third frequency band of the band pair, or both.

Aspect 13: A method for wireless communication at a network entity, comprising: receiving first capability information that indicates a first frequency band is associated with a first band changing capability, wherein the first band changing capability indicates a UE will maintain a mapping between a first transmit chain of the UE and the first frequency band while performing other scheduled frequency band switches using a second transmit chain of the UE; receiving second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, wherein the second switching time period is longer than the first switching time period; transmitting scheduling information that schedules a change between communications by the UE on a band pair, that includes the first frequency band and the third frequency band, and communications by the UE on the second frequency band, wherein a switch between the band pair and the second frequency band comprises the first switch and the second switch, the first switching time period of the first switch overlapping in time with the second switching time period of the second switch; and receiving a message after at least a portion of the switching, wherein reception of the message is in accordance with a scheduling rule that defines whether transmission by the UE is allowed during a conditional transmission time that is after completion of the first switching time period and before completion of the second switching time period.

Aspect 14: The method of aspect 13, wherein the second frequency band is associated with the first band changing capability, and wherein receiving the message comprises: receiving the message during the conditional transmission time that is after the completion of the first switching time period and before the completion of the second switching time period based at least in part on the scheduling rule, wherein the scheduling rule defines that transmission by the UE is allowed during the conditional transmission time when the first switch is between two frequency bands associated with the first band changing capability.

Aspect 15: The method of aspect 14, wherein receiving the first capability information comprises: receiving, via the first capability information, an indication that the second frequency band is associated with the first band changing capability.

Aspect 16: The method of any of aspects 14 through 15, wherein the switch is from the band pair to the second frequency band; and the message is received on the second frequency band during the conditional transmission time.

Aspect 17: The method of any of aspects 14 through 15, wherein the switch is from the second frequency band to the band pair; and the message is received on the first frequency band of the band pair during the conditional transmission time.

Aspect 18: The method of any of aspects 14 through 17, wherein transmitting the scheduling information comprises: transmitting, via the scheduling information, an indication of resources allocated for the message during the conditional transmission time based at least in part on the scheduling rule.

Aspect 19: The method of aspect 13, wherein receiving the message comprises: receiving the message after the completion of the second switching time period based at least in part on the scheduling rule, wherein the scheduling rule defines that transmission by the UE is not allowed during the conditional transmission time when a single frequency band of a set of frequency bands is associated with the first band changing capability, the set of frequency bands comprising the first frequency band, the second frequency band, and the third frequency band.

Aspect 20: The method of aspect 19, wherein transmitting the scheduling information comprises: transmitting, via the scheduling information, an indication of resources allocated for the message after the completion of the second switching time period based at least in part on the scheduling rule.

Aspect 21: The method of any of aspects 13 through 20, wherein transmitting the scheduling information comprises: transmitting, via the scheduling information, information that schedules a change from the band pair to the second frequency band, wherein the scheduling information schedules the message on the second frequency band.

Aspect 22: The method of any of aspects 13 through 20, wherein transmitting the scheduling information comprises: transmitting, via the scheduling information, information that schedules a change from the second frequency band to the band pair, wherein the scheduling information schedules the message on the first frequency band of the band pair, the third frequency band of the band pair, or both.

Aspect 23: A UE for wireless communication, comprising a processor; memory coupled with the processor; and instructions stored in the memory and executable by the processor to cause the UE to perform a method of any of aspects 1 through 12.

Aspect 24: An apparatus for wireless communication at a UE, comprising at least one means for performing a method of any of aspects 1 through 12.

Aspect 25: A non-transitory computer-readable medium storing code for wireless communication at a UE, the code comprising instructions executable by a processor to perform a method of any of aspects 1 through 12.

Aspect 26: A network entity for wireless communication at a network entity, comprising a processor; memory coupled with the processor; and instructions stored in the memory and executable by the processor to cause the network entity to perform a method of any of aspects 13 through 22.

Aspect 27: An apparatus for wireless communication at a network entity, comprising at least one means for performing a method of any of aspects 13 through 22.

Aspect 28: A non-transitory computer-readable medium storing code for wireless communication at a network entity, the code comprising instructions executable by a processor to perform a method of any of aspects 13 through 22.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
a processor;
memory coupled with the processor; and
instructions stored in the memory and executable by the processor to cause the UE to:
transmit first capability information that indicates a first frequency band is associated with a first band changing capability, wherein the first band changing capability indicates the UE will maintain a mapping between a first transmit chain of the UE and the first frequency band while performing other scheduled frequency band switches using a second transmit chain of the UE;
transmit second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, wherein the second switching time period is longer than the first switching time period;
receive scheduling information that schedules a change between communications by the UE on a band pair, that includes the first frequency band and the third frequency band, and communications by the UE on the second frequency band;
switch between the band pair and the second frequency band based at least in part on the scheduling information, wherein the switching comprises the first switch and the second switch, the first switching time period of the first switch overlapping in time with the second switching time period of the second switch; and
transmit a message after at least a portion of the switching, wherein transmission of the message is in accordance with a scheduling rule that defines whether transmission is allowed during a conditional transmission time that is after completion of the first switching time period and before completion of the second switching time period.

2. The UE of claim 1, wherein the second frequency band is associated with the first band changing capability, and wherein the instructions to transmit the message are executable by the processor to cause the UE to:
transmit the message during the conditional transmission time that is after the completion of the first switching time period and before the completion of the second switching time period based at least in part on the scheduling rule, wherein the scheduling rule defines that transmission is allowed during the conditional transmission time when the first switch is between two frequency bands associated with the first band changing capability.

3. The UE of claim 2, wherein the instructions to transmit the first capability information are executable by the processor to cause the UE to:
transmit, via the first capability information, an indication that the second frequency band is associated with the first band changing capability.

4. The UE of claim 2, wherein the instructions to switch between the band pair and the second frequency band are executable by the processor to cause the UE to:
switch from the band pair to the second frequency band, wherein the message is transmitted on the second frequency band using the first transmit chain of the UE during the conditional transmission time.

5. The UE of claim 2, wherein the instructions to switch between the band pair and the second frequency band are executable by the processor to cause the UE to:
switch from the second frequency band to the band pair, wherein the message is transmitted on the first frequency band of the band pair using the first transmit chain of the UE during the conditional transmission time.

6. The UE of claim 2, wherein the instructions to receive the scheduling information are executable by the processor to cause the UE to:
receive, via the scheduling information, an indication of resources allocated for the transmission of the message during the conditional transmission time based at least in part on the scheduling rule.

7. The UE of claim 2, wherein the instructions are further executable by the processor to cause the UE to:
transmit a second message after the completion of the second switching time period, wherein the second message is transmitted using the first transmit chain of the UE, the second transmit chain of the UE, or both.

8. The UE of claim 1, wherein the instructions to transmit the message are executable by the processor to cause the UE to:
transmit the message after the completion of the second switching time period based at least in part on the scheduling rule, wherein the scheduling rule defines that transmission is not allowed during the conditional transmission time when a single frequency band of a set of frequency bands is associated with the first band changing capability, the set of frequency bands comprising the first frequency band, the second frequency band, and the third frequency band.

9. The UE of claim 8, wherein the instructions to receive the scheduling information are executable by the processor to cause the UE to:
receive, via the scheduling information, an indication of resources allocated for the transmission of the message after the completion of the second switching time period based at least in part on the scheduling rule.

10. The UE of claim 1, wherein the instructions to switch between the band pair and the second frequency band are executable by the processor to cause the UE to:
switch the first transmit chain of the UE between the first frequency band and the second frequency band during the first switching time period; and
switch the second transmit chain of the UE between the third frequency band and the second frequency band during the second switching time period.

11. The UE of claim 1, wherein the instructions to switch between the band pair and the second frequency band are executable by the processor to cause the UE to:
switch from the band pair to the second frequency band in accordance with the scheduling information, wherein the scheduling information schedules the transmission of the message on the second frequency band.

12. The UE of claim 1, wherein the instructions to switch between the band pair and the second frequency band are executable by the processor to cause the UE to:
switch from the second frequency band to the band pair in accordance with the scheduling information, wherein the scheduling information schedules the transmission of the message on the first frequency band of the band pair, the third frequency band of the band pair, or both.

13. A network entity for wireless communication, comprising: a processor;
memory coupled with the processor; and
instructions stored in the memory and executable by the processor to cause the network entity to:
receive first capability information that indicates a first frequency band is associated with a first band changing capability, wherein the first band changing capability indicates a user equipment (UE) will maintain a mapping between a first transmit chain of the UE and the first frequency band while performing other scheduled frequency band switches using a second transmit chain of the UE;
receive second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, wherein the second switching time period is longer than the first switching time period;
transmit scheduling information that schedules a change between communications by the UE on a band pair, that includes the first frequency band and the third frequency band, and communications by the UE on the second frequency band, wherein a switch between the band pair and the second frequency band comprises the first switch and the second switch, the first switching time period of the first switch overlapping in time with the second switching time period of the second switch; and
receive a message after at least a portion of the switching, wherein reception of the message is in accordance with a scheduling rule that defines whether transmission by the UE is allowed during a conditional transmission time that is after completion of the first switching time period and before completion of the second switching time period.

14. The network entity of claim 13, wherein the second frequency band is associated with the first band changing capability, and wherein the instructions to receive the message are executable by the processor to cause the network entity to:
receive the message during the conditional transmission time that is after the completion of the first switching time period and before the completion of the second switching time period based at least in part on the scheduling rule, wherein the scheduling rule defines that transmission by the UE is allowed during the conditional transmission time when the first switch is between two frequency bands associated with the first band changing capability.

15. The network entity of claim 14, wherein the instructions to receive the first capability information are executable by the processor to cause the network entity to:
receive, via the first capability information, an indication that the second frequency band is associated with the first band changing capability.

16-17. (canceled)

18. The network entity of claim 14, wherein the instructions to transmit the scheduling information are executable by the processor to cause the network entity to:
transmit, via the scheduling information, an indication of resources allocated for the message during the conditional transmission time based at least in part on the scheduling rule.

19-22. (canceled)

23. A method for wireless communication at a user equipment (UE), comprising:
transmitting first capability information that indicates a first frequency band is associated with a first band changing capability, wherein the first band changing capability indicates the UE will maintain a mapping between a first transmit chain of the UE and the first frequency band while performing other scheduled frequency band switches using a second transmit chain of the UE;
transmitting second capability information that indicates a first switching time period and a second switching time period supported by the UE, the first switching time period pertains to a first switch, by the UE, between the first frequency band and a second frequency band, and the second switching time period pertains to a second switch, by the UE, between a third frequency band and the second frequency band, wherein the second switching time period is longer than the first switching time period;
receiving scheduling information that schedules a change between communications by the UE on a band pair, that includes the first frequency band and the third frequency band, and communications by the UE on the second frequency band;
switching between the band pair and the second frequency band based at least in part on the scheduling information, wherein the switching comprises the first switch and the second switch, the first switching time period of the first switch overlapping in time with the second switching time period of the second switch; and
transmitting a message after at least a portion of the switching, wherein transmission of the message is in accordance with a scheduling rule that defines whether transmission is allowed during a conditional transmission time that is after completion of the first switching time period and before completion of the second switching time period.

24. The method of claim 23, wherein the second frequency band is associated with the first band changing capability, and wherein transmitting the message comprises:
transmitting the message during the conditional transmission time that is after the completion of the first switching time period and before the completion of the second switching time period based at least in part on the scheduling rule, wherein the scheduling rule defines that transmission is allowed during the conditional transmission time when the first switch is between two frequency bands associated with the first band changing capability.

25. The method of claim 24, wherein transmitting the first capability information comprises:
transmitting, via the first capability information, an indication that the second frequency band is associated with the first band changing capability.

26. The method of claim 24, wherein receiving the scheduling information comprises:
receiving, via the scheduling information, an indication of resources allocated for the transmission of the message during the conditional transmission time based at least in part on the scheduling rule.

27-30. (canceled)
